(19) United States
(12) Patent Application Publication
(10) Pub. No.: US 2022/0167211 A1
(43) Pub. Date: May 26, 2022

(54) Method and System for Local Area Data Network (LADN) Selection Based on Dynamic Network Conditions

(71) Applicant: Telefonaktiebolaget LM Ericsson (PUBL), Stockholm (SE)

(72) Inventors: Nipun Sharma, NEW DELHI (IN); Rakesh Bajpai, New Delhi (IN); Hans Eriksson, SOLLENTUNA (SE); Tushar Sabharwal, NEW Delhi (IN); Rajiv Bhardwaj, Jalandhar (IN)

(21) Appl. No.: 17/435,068

(22) PCT Filed: Mar. 1, 2019
(86) PCT No.: PCT/SE2019/050178

§ 371 Date: Aug. 31, 2021

(51) Int. Cl. H04W 28/08

(52) U.S. Cl. CPC H04W 28/0942; H04W 28/0967; H04W 28/095; H04W 28/0933; H04W 28/0842

(57) ABSTRACT

According to certain embodiments, a method for use in a network node comprises receiving a request to connect a session of a wireless device. The wireless device is located in a service area of a Local Area Data Network (LADN) and a subscription associated with the wireless device permits access to the LADN. The method further comprises determining whether to select the LADN for the session. The determining is based on one or more factors associated with the LADN. The one or more factors comprise at least one of the following: loading conditions, service quality, historic data, and subscriber priority. The method further comprises sending, to another network node, a message indicating whether the LADN has been selected for the session.

### TECHNICAL FIELD

Certain embodiments of the present disclosure relate to data networks and, more particularly, to Local Area Data Network (LADN) selection based on dynamic network conditions.

### BACKGROUND

The 3rd Generation Partnership Project (3GPP) unites a number of telecommunications standard development organizations and provides their members with an environment to produce the Technical Reports and Technical Specifications that define 3GPP technologies. 3GPP Technical Specifications cover various telecommunications network technologies, including radio access, the core transport network, and service capabilities. 3GPP is currently developing a Fifth Generation (5G) architecture.

The 5G architecture introduces the concept of a Local Area Data Network (LADN). Access to a Data Network (DN) via a Protocol Data Unit (PDU) Session for a LADN is only available in a specific LADN service area, which comprises a set of Tracking Areas. A serving Public Land Mobile Network (PLMN) provides the LADN service, and the LADN service includes the following characteristics:
LADN service applies only to 3GPP accesses and does not apply to Home Routed accesses.
The usage of a Data Network Name (DNN) associated with a LADN requires an explicit subscription to this DNN or subscription to a wildcard DNN.
Whether a DNN corresponds to a LADN service is an attribute of the DNN.

A user equipment (UE) is configured to know whether a DNN is a LADN DNN. The UE is also configured to know an association between an application and the LADN DNN.

In the 5G architecture, an Access and Mobility Management function (AMF) may support various functionality, such as registration management, connection management, mobility management, access authentication and authorization, security context management, and/or non-access stratum (NAS)-related functionality. Configuration information in the AMF may include a LADN service area and a LADN DNN configured on a per DN basis. Thus, the configured LADN service area is the same for different UEs accessing the same LADN, regardless of other factors, such as the UE's Registration Area or the UE's subscription.

The AMF provides the UE with LADN Information (i.e., LADN Service Area Information and LADN DNN) during the Registration procedure or UE Configuration Update procedure. For each LADN DNN configured in the AMF, the corresponding LADN Service Area Information includes a set of Tracking Areas that belong to the Registration Area that the AMF assigns to the UE (i.e., the intersection of the LADN service area and the assigned Registration Area).

When the UE performs a successful registration or re-registration procedure, the AMF may provide the UE with LADN Information for the list of LADN(s) available to the UE in that Registration Area. The AMF may determine the LADN information to provide to the UE based on configuration about the LADN (e.g., as configured via Operation and Maintenance (OAM)), UE location, and/or UE subscription information received from the User Data Management (UDM) about subscribed DNN(s). The AMF may provide the LADN information in the Registration Accept message. The list of LADNs available to the UE is determined as following:
If neither the LADN DNN nor an indication of requesting LADN Information is provided in the Registration Request message, the list of LADNs is the LADN DNN(s) in the subscribed DNN list except for a wildcard DNN.
If the UE provides the LADN DNN(s) in the Registration Request message, the list of LADN is the LADN DNN(s) that the UE requested if the UE subscribed DNN(s) includes the requested LADN DNN(s) or if a wildcard DNN is included in the UE's subscription data.
If the UE provides an indication of requesting LADN Information in the Registration Request message, the list of LADN(s) is all the LADN DNN(s) configured in the AMF if the wildcard DNN is subscribed, or the LADN DNN(s) which is in subscribed DNN list if no wildcard DNN is subscribed.

When receiving PDU Session Establishment with the LADN DNN or Service Request with the established PDU Session corresponding to the LADN, the AMF determines the presence of the UE in the LADN service area and forwards it to the Session Management Function (SMF) if the requested DNN is configured at the AMF as a LADN DNN.

When the SMF receives a Session Management (SM) request corresponding to a LADN from the AMF, the SMF determines whether the UE is inside the LADN service area based on the indication (i.e., UE Presence in the LADN service area) received from the AMF. If the SMF does not receive the indication, the SMF considers the UE to be outside of the LADN service area. The SMF shall reject the request if the UE is outside of the LADN service area.

If the SMF determines that the UE is inside the LADN service area, the SMF then selects the User Plane Function (UPF) as per the LADN information. This selection helps subscriber in connecting to most suitable (nearest) UPF and Application Server (AS).

Currently, AMF policies regarding the location co-ordinates of the UE are used to determine whether the UE may attach to an AS (edge based, LADN), for example, based on whether the UE is in a specific location associated with the LADN. As an example, a LADN may be defined for a Manhattan service area, and a Netflix application server (edge server) may be installed in the Manhattan service area for superior experience as there is a large number of users in the specific area (high densification). The AMF policies determine whether the user may connect to the Netflix server in Manhattan (for superior experience) or to a centralized Netflix server somewhere in the US (i.e., a server that is not specific to a LADN) for regular service. Although the previous example describes a Manhattan service area, the network may include any suitable LADN service area(s), such as a service area for downtown Seattle, a service area for Chicago, or other location.

### SUMMARY

There currently exist certain challenge(s). Currently, the decision to select a LADN is taken based on the location of the UE and its subscription. There are multiple factors that can adversely affect the efficacy of this solution if not considered in the selection criteria. For example, suppose an Application Server in the LADN is overloaded and cannot handle more subscriber traffic at a particular time. Because the LADN implementation causes all new sessions from valid LADN subscribers in the same geographical location to connect to the Application Server associated with the LADN, the AMF will not select other, central Application Servers that are not overloaded. In other words, controlling the selection of the Application Server only on the basis of location and subscription causes the same overloaded Application Server to be selected for all LADN subscribers located in the geographical location of the LADN. Adding new sessions to an overloaded Application Server in the LADN worsens the customer experience for existing as well as new customers to be added. This may deteriorate the subscriber experience and may cause network failure.

Certain aspects of the present disclosure and their embodiments may provide solutions to these or other challenges. In certain embodiments, the above-described issues can be resolved by including other factors in consideration. One factor that may be considered in determining whether a session may use LADN services (e.g., attach to an Application Server associated with an LADN) includes historic data, patterns, etc., which may be used to predict and mitigate the overload situation. For example, an operator would like to predict the overload conditions for Application Servers to enable proactive action/planning to avoid any degradation of customer experience.

Another factor that may be considered in determining whether a session may use LADN services (e.g., attach to an Application Server associated with an LADN) includes priority of the subscriber. Subscribers to LADN services (superior experience) may be prioritized based on respective revenue generated, for example. The revenue generated may be assessed generally or for specific use-cases, such as recent use-cases. As an example, suppose that a customer with a platinum level subscription plan generates $55 in revenue per month, plus $6 per month for LADN services. Further suppose that a customer with a silver level subscription plan generates $35 in revenue per month, plus $9 per month for LADN services. Certain network operators may opt to configure policies that cause the platinum subscriber to have higher priority access to the LADN services because the platinum subscribers generate more total revenue. Other network operators may opt to configure policies that cause the silver level subscribers to have higher priority access to the LADN services because the silver level subscribers generate more LADN revenue. In either case, both platinum and silver level subscribers would be granted access to LADN services when the network has sufficient capacity. The higher priority subscribers would be granted access to LADN services and the lower priority subscribers may be denied access to LADN services when the LADN resources are overloaded or at risk of becoming overloaded.

There are, proposed herein, various embodiments which address one or more of the issues disclosed herein. In general, the present disclosure provides systems and methods to select the LADN to avoid and manage overload situations.

According to certain embodiments, a method for use in a network node comprises obtaining information from other network nodes of various types, collecting the information over a period of time, and using the collected information to build a topology that indicates characteristics of one or more LADNs and one or more centralized networks.

According to certain embodiments, a network node comprises processing circuitry configured to obtain information from other network nodes of various types, collect the information over a period of time, and use the collected information to build a topology that indicates characteristics of one or more LADNs and one or more centralized networks.

According to certain embodiments, a computer program comprises instructions which, when executed on a computer, cause the computer to obtain information from other network nodes of various types, collect the information over a period of time, and use the collected information to build a topology that indicates characteristics of one or more LADNs and one or more centralized networks.

The above-described method, network node, and/or computer program may include any suitable additional features, such as one or more of the following features:

In some embodiments, the topology is used in determining a recommended LADN or centralized network for providing a service to a wireless device that is located in a particular location at a particular time. In some embodiments, the recommended LADN or centralized network is further determined based at least in part on whether selecting the recommended LADN or centralized network for the wireless device at the particular location would increase revenue, improve service quality, or both.

In some embodiments, a message is sent to another network node to indicate the recommended LADN or centralized network. The second network node is configured to facilitate connecting the wireless device with the recommended LADN or centralized network.

In certain embodiments, the information obtained from the other network nodes comprises one or more of information indicating latency of one or more application functions in the network, information indicating traffic throughput of one or more application functions in the network, information indicating IP address ranges associated with the LADN, information indicating revenue associated with a subscriber, information indicating a location of the LADN, information indicating whether a service area of the LADN overlaps the service area of another LADN, information indicating a load of the LADN, information indicating a load of network segments that application traffic is carried over, and information indicating a location of a wireless device. Thus, in certain embodiments, the information can include a combination of any of the foregoing, whether combined together or with other information.

In certain embodiments, the other network nodes from which the information is obtained comprise one or more of an Application Function (AF), an Application Server (AS), a Session Management Function (SMF), a Base Station System (BSS), an Operations Support System (OSS), a LADN Virtual Network Function Instance (VNFI), a position system, and a Mobility Management Entity (MME). Thus, in certain embodiments, the information can be obtained from a combination of any of the foregoing network nodes (and optionally, additional information can be obtained from other types of network nodes).

In certain embodiments, the network node that provides the above-described features comprises an NWDAF. In certain embodiments, the network node is configured to operate in a network that comprises a central data center and an edge data center. The edge data center can include the LADN and the network node, or the edge data center can include the LADN while the central data center comprises the network node.

According to certain embodiments, a method for use in a network node comprises receiving a request to connect a session of a wireless device. The wireless device is located in a service area of a LADN and a subscription associated with the wireless device permits access to the LADN. The method further comprises determining whether to select the LADN for the session. The determining is based on one or more factors associated with the LADN. The one or more factors comprise at least one of the following: loading conditions, service quality, historic data, and subscriber priority. The method further comprises sending, to another network node, a message indicating whether the LADN has been selected for the session.

According to certain embodiments, a network node comprises processing circuitry configured to receive a request to connect a session of a wireless device. The wireless device is located in a service area of a LADN and a subscription associated with the wireless device permits access to the LADN. The processing circuitry is further configured to determine whether to select the LADN for the session. The determination is based on one or more factors associated with the LADN. The one or more factors comprise at least one of the following: loading conditions, service quality, historic data, and subscriber priority. The processing circuitry is further configured to send, to another network node, a message indicating whether the LADN has been selected for the session.

According to certain embodiments, a computer program comprises instructions which, when executed on a computer, cause the computer to receive a request to connect a session of a wireless device. The wireless device is located in a service area of a LADN and a subscription associated with the wireless device permits access to the LADN. The instructions further cause the computer to determine whether to select the LADN for the session. The determination is based on one or more factors associated with the LADN. The one or more factors comprise at least one of the following: loading conditions, service quality, historic data, and subscriber priority. The instructions further cause the computer to send, to another network node, a message indicating whether the LADN has been selected for the session.

The above-described method, network node, and/or computer program may include any suitable additional features, such as one or more of the following features:

In certain embodiments, the LADN is not selected when the loading conditions indicate that the LADN is overloaded.

In certain embodiments, the LADN is not selected when the service quality in the LADN is degraded.

In certain embodiments, the LADN is not selected when the historic data predicts that the LADN is at risk of becoming overloaded or the service quality in the LADN is at risk of becoming degraded.

In certain embodiments, the LADN is selected when the historic data predicts that the LADN is likely to provide the session with better service quality than other networks that are available for selection.

In certain embodiments, the loading conditions, the service quality, and/or the historic data are used to determine whether to use the subscriber priority as one of the factors for determining whether to select the LADN. As an example, when the loading conditions, the service quality, and/or the historic data indicate that there is no need to restrict selection of the LADN, the LADN is selected for the session regardless of the subscriber priority. As another example, when the loading conditions, the service quality, and/or the historic data indicate a need to restrict selection of the LADN, the LADN is selected when the subscription associated with the wireless device corresponds to a higher priority subscriber and the LADN is not selected when the subscription associated with the wireless device corresponds to a lower priority subscriber. In certain embodiments, the subscriber priority is based at least in part on ARPU associated with the subscriber. The ARPU may be based on total revenue or LADN-specific revenue.

In certain embodiments, the message sent to the second network node indicates that the LADN has been selected. In certain embodiments, the message sent to the second network node indicates that a different LADN has been selected. In certain embodiments, the message sent to the second network node indicates that a centralized session has been selected for the session.

In certain embodiments, the first network node provides/comprises an AMF and the second network node provides/comprises an SMF. In certain embodiments, the one or more factors are obtained from a network node that collects data and provides data analytics for the network, such as an NWDAF (e.g., which may be located in an edge data center or a central data center, depending on the embodiment).

Any of the above-described methods may be performed by a computer program. The computer program comprises instructions, such as program code, which, when executed on a computer, perform a method. In certain embodiments, a computer program product may comprise the computer program. In certain embodiments, a non-transitory computer-readable storage medium may comprise the computer program.

Certain embodiments may provide one or more of the following technical advantage(s). As an example, certain embodiments may avoid network failure due to already overloaded Application Functions in the LADN. As another example, certain embodiments may proactively avoid the overload and congestion situations which deteriorate the user experience. As another example, certain embodiments may, in case of overload situation, ensure that the service experience of the high priority subscribers is maintained.

### BRIEF DESCRIPTION OF DRAWINGS

FIG. 1: Example network with a centralized NWDAF and NEF, in accordance with some embodiments.

FIG. 2: Example network with a centralized NWDAF and NEF, in accordance with some embodiments.

FIG. 3: Current call flow for LADN.

FIG. 4: Example sequence for populating the AFx & Service status to NWDAF, in accordance with some embodiments.

FIG. 5: Example sequence for populating the AFx & Service status (from different AFx) to NWDAF, in accordance with certain embodiments.

FIG. 6: Example method of provisioning LADN services in NEF, in accordance with some embodiments.

FIG. 7: Example method by which NWDAF learns the topology, in accordance with some embodiments.

FIG. 8: Example method in which NWDAF obtains inputs from BSS/Data Warehouse, in accordance with some embodiments.

FIG. 9: Example method in which NWDAF obtains inputs from OSS, in accordance with some embodiments.

FIG. 10: Example of Federated Learning between LADN NWDAF and Central NWDAF, in accordance with some embodiments.

FIG. 11: Example method for requesting “best” LADN with reinforced learning, in accordance with some embodiments.

FIG. 12: Example of an enhanced call flow for a new UE Connection, in accordance with some embodiments.

FIG. 13: Current call flow for when UE moves to LADN area.

FIG. 14: Example of an enhanced call flow when UE moves to LADN Area, in accordance with some embodiments.

FIG. 15: Example of an enhanced call flow with overload prediction, in accordance with some embodiments.

FIG. 16: Current call flow with different priority subscribers.

FIG. 17: Example of an enhanced call flow with different priority subscribers, in accordance with certain embodiments.

FIG. 18: Example of an enhanced call flow with different priority subscribers, in accordance with certain embodiments.

FIG. 19: Example of a method performed by a network node, in accordance with certain embodiments.

FIG. 20: Example of a method performed by a network node, in accordance with certain embodiments.

FIG. 21: Example of a network node, in accordance with certain embodiments.

FIG. 22: Example of a network node, in accordance with certain embodiments.

FIG. 23: A wireless network in accordance with some embodiments.

FIG. 24: User Equipment in accordance with some embodiments

FIG. 25: Virtualization environment in accordance with some embodiments

FIG. 26: Telecommunication network connected via an intermediate network to a host computer in accordance with some embodiments

FIG. 27: Host computer communicating via a base station with a user equipment over a partially wireless connection in accordance with some embodiments

FIG. 28: Methods implemented in a communication system including a host computer, a base station and a user equipment in accordance with some embodiments

FIG. 29: Methods implemented in a communication system including a host computer, a base station and a user equipment in accordance with some embodiments

FIG. 30: Methods implemented in a communication system including a host computer, a base station and a user equipment in accordance with some embodiments

FIG. 31: Methods implemented in a communication system including a host computer, a base station and a user equipment in accordance with some embodiments

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As discussed above, LADN helps in optimizing the use of edge computing so that subscribers are connected to a “nearby” Application Server (e.g., an Application Server that is nearby according to geographical location or network topology or is otherwise accessible with relatively low latency compared to a “centralized” Application Server). Connecting to a “nearby” Application Server can provide location specific services, lower delay, and less data requirements throughout the transport network. As an example, subscribers in a stadium can be connected to a LADN that is implemented by deploying UPF & Application Function on the premises of the stadium. This service may include the video streaming of the match.

Certain embodiments of the present disclosure address the problem that, if there is overload on the Application function in LADN or congestion in the network, that overload or congestion is not considered in the LADN selection. Rather, selection of LADN is currently controlled only on the basis of location and subscription. Thus, the same Application function will be selected for all subscribers even when the Application function is overloaded. This can cause network failure and worsen the subscriber experience. To limit such degradation, certain embodiments of the present disclosure provide methods for the LADN selection to take into account other relevant factors. For example, by considering the node status, congestion situation, historical data, and subscriber priority this degradation can be avoided and customer experience can be enhanced.

The present disclosure proposes systems and methods to avoid and manage overload situations in the network by incorporating additional factors in selection of the LAD N. To further elaborate, LADN selection can be improved by taking into consideration one or more of the following factors:

1. Trusted/Untrusted Application Server/Application Function is Overloaded or not

Before selecting the LADN (UPF\Application Function), the AMF also considers the load situation of the Application Function. If the nodes are overloaded, the AMF chooses not to select the LADN for this subscriber request. Instead, the subscriber uses the “central” servers as per the normal Packet Data Network (PDN) Session Connection. This will be true even for use-cases where the user is roaming with an ongoing session connected to a centralized server and is approaching a location for shifting to a localized LADN server/AS.

2. Service Quality in the Network for LADN Services

Before selecting the LADN (UPF′Application Function), the AMF also considers the Service Quality possible in the network. Service Quality may deteriorate due to many reasons, e.g., congestion in the transport network, bad radio conditions, etc. The Application Function can measure the service quality for a subscriber and report it to a Network Data Analytics Function (NWDAF) via a Network Exposure Function (NEF). Service Quality can be measured by the AF in terms of available bandwidth, packet loss, service retries, etc.

3. Historical Data/Pattern Regarding the Application Function Overload/Congestion

Based on previous Overload & Congestion situations, it can be predicted when the system is going to be overloaded. This situation can be avoided by not using LADN and selecting “central” Application Servers proactively.

4. Prioritize LADN Subscribers During Overload Situation.

If an overload situation happens, priority subscribers are allowed to use LADN for better service experience. Non-priority subscribers are either moved to outside the LADN AS where central servers are used for accessing the services. As an example, priority may be determined based on subscriber profiles. In some embodiments, subscriber priority may be determined based on revenue, such as Average Revenue Per User (ARPU). As examples, certain policies may prioritize subscribers based on total revenue or LADN revenue. Revenue may be evaluated based on the subscriber's subscription plan and/or recent usage patterns.

In the examples, “central” or “centralized” may generally refer to resources (e.g., server, application function, service, etc.) that are not associated with a LADN. Typically, LADN resources provide a superior experience compared to centralized resources, assuming that the LADN resources are not experiencing overload or some other condition that degrades performance.

The discussion below elaborates on the proposed solutions to select the LADN based on multiple factors that will assist the operator in avoiding overload of the Application Function and prioritizing the customer experience for superior customers (high revenue generating customers).

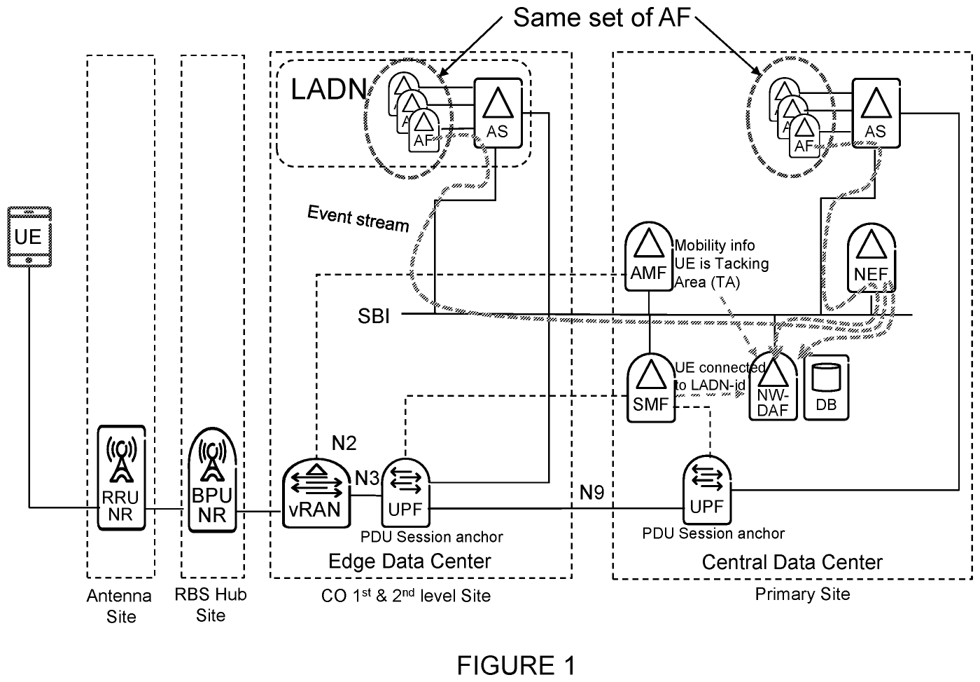

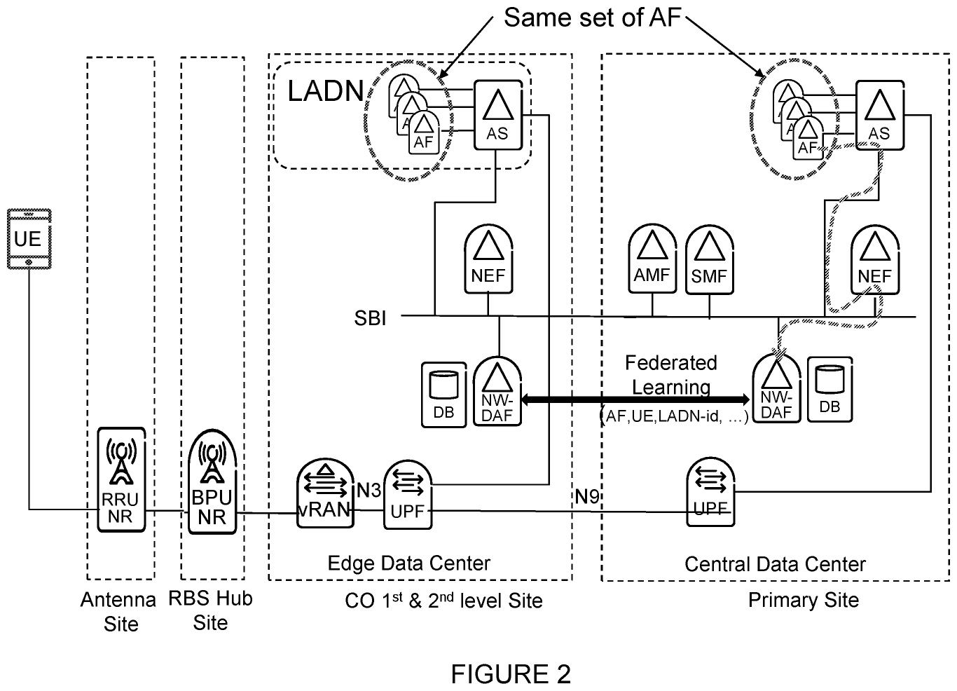

FIGS. 1 and 2 illustrate two ways of deploying an LADN. In FIG. 1, network elements like NWDAF and NEF are deployed for the whole network at a centralized location. Both LADN and non-LADN services integrate with these functions. However, the Application function will be deployed at Local Area Data Network. FIG. 2 illustrates an alternative deployment where there are separate NWDAF and NEF for LADN service. So, AF related information is updated in LADN NEF and NWDAF first. There is also connectivity between the central NWDAF and the LADN NWDAF for federated learning. For simplicity, the description below will be provided based on the deployment of FIG. 1. The same call flows can be used for the deployment of FIG. 2 by assuming that the displayed NWDAF is the Central NWDAF.

FIGS. 1 and 2 illustrate an example of a UE, which may connect to the network via an antenna site. Within the network, the antenna site may connect to a radio base station (RBS) hub site, the RBS hub site may connect to a central office (CO) (1st level and 2nd level) site, and the CO may connect to a primary site. In certain embodiments, the antenna site may include one or more radio receive units (RRUs), the RBS hub site may include one or more baseband processing units (BPUs), the CO site may include an edge data center, and the primary cite may include a central data center. As an example, for a city serving approximately 3 million subscribers, a network may include approximately 200 antenna sites per city, approximately 10 to 20 RBS hub sites per city, and one or two CO sites per city. The network may include approximately 2-4 primary sites per country. Other networks may use different numbers of the various types of sites or may distribute functionality of the different sites in a different manner, for example, depending on the number and density of subscribers or other factors.

As further discussed below, certain embodiments of the present disclosure use the NWDAF to determine performance insights based on information obtained from various other nodes. In the example of FIG. 1 (NWDAF located in the central data center), the NWDAF may determine performance insights from a central perspective (e.g., based on one or more of AF-id, UE-id, and PDU Session anchor) and from a LADN perspective (e.g., based on one or more of AF-id, UE-id, LADN-id, and PDU Session anchor). In the example of FIG. 2, (NWDAFs located in both the edge data center and the central data center), the NWDAF located in the edge data center may determine performance insights from a LADN perspective (e.g., based on one or more of AF-id, UE-id, and LADN-id), and the NWDAF located in the central data center may determine performance insights from a central perspective (e.g., based on one or more of AF-id, UE-id, tracking area (TA), PDU Session anchor (central)) and from a LADN perspective (e.g., based on one or more of AF-id, UE-id, TA, LADN-id, or PDU Session anchor (LADN-id)).

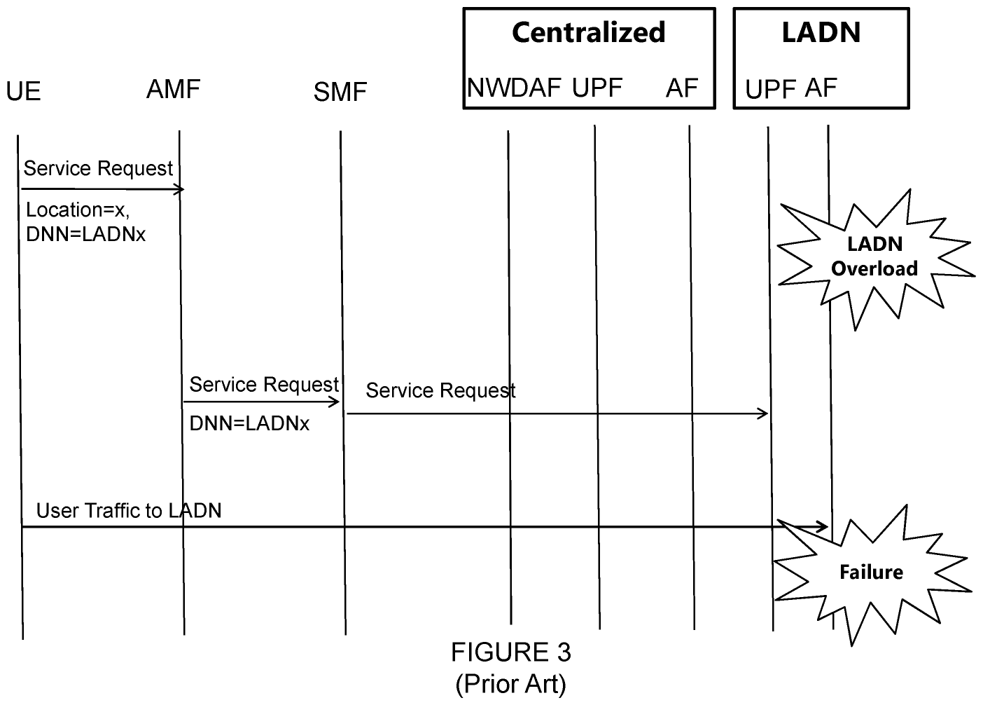

FIG. 3 provides an example of an existing call flow and illustrates an example of a problem addressed by embodiments of the present disclosure. In the existing 5G architecture, the UE attaches to an Application server (AS) (edge based, LADN) if the UE is located in a specific location (LADN) according to an AMF policy regarding location co-ordinates. For example, a Netflix server may be installed in a Manhattan service area for superior experience (LADN) as there is a large number of users in the specific area (high densification). Currently, the decision to connect to the Netflix server in the Manhattan service area is taken based on location and subscription of the UE (attaching to LADN), which is based on static configuration and does not include the dynamic condition of the network for optimized decision making. So, the AMF does not consider the overload situation and all requests are sent to the LADN. In fact, in the existing 5G architecture, the AMF does not even have full view of the network and Application Server, therefore limiting its decision making capability.

As shown in FIG. 3, when the UE performs a successful registration (or re-registration) procedure, the AMF may send the UE a Registration Accept message that provides LADN information indicating the list of LADNs available to the UE in that Registration Area. The LADN information is based on local configuration (e.g., via OAM) about LADN, UE location, and UE subscription information received from the UDM about DNN(s) to which the UE subscribes.

1. When the UE is in a LADN service area, the UE:
may request a PDU Session Establishment/Modification for this LADN DNN;
may request to activate UP connection of the existing PDU Session for this LADN DNN.

2. UE sends PDU Session Establishment with LADN DNN or Service Request with the established PDU Session corresponding to LADN.

3. The AMF determines UE presence in LADN service area and forwards it to the SMF if the requested DNN is configured at the AMF as a LADN DNN.

4. The SMF supporting a DNN is configured with information about whether this DNN is a LADN DNN or not. When receiving SM request corresponding an LADN from the AMF, the SMF determines whether the UE is inside LADN service area based on the indication (i.e. UE Presence in LADN service area) received from the AMF. If the SMF does not receives the indication, the SMF considers that the UE is outside of the LADN service area (the SMF then rejects the request if the UE is outside of the LADN service area). The SMF subscribes to “UE mobility event notification” for reporting UE presence in Area of Interest by providing LADN DNN to the AMF.

5. When SMF is informed that the UE presence a LADN service area is IN, the SMF ensures that Downlink Data Notification is enabled. Triggers the Network triggered Service Request procedure for a LADN PDU Session to active the UP connection when the SMF receives downlink data or Data Notification from UPF.

6. UE is then able to create data connection with AF which is part of LADN.

Because selection of the LADN in the existing method of FIG. 3 is based on limited factors (user's subscription and location), FIG. 3 illustrates that the UE may be assigned to an overloaded LADN (e.g., overloaded Application Function or overloaded Application Server), which may result in degraded performance or network failure.

To address this problem, embodiments of the present disclosure propose multiple factors that should also be evaluated when deciding whether or not to connect to the UPF/LADN—even if location co-ordination point are fulfilled (AMF based policy). For simplicity, the proposed solutions are discussed in two parts:

a) Pre Collection Phase: Populating the relevant information from different network functions (NFs) towards NWDAF

b) Post Collection Phase: Using the information available at NWDAF for optimized decision making e.g. Selection/deselection/prioritization needed for overloading conditions.

### Pre Collection Phase:

During the pre-collection phase, relevant information from different network functions (NFs) may be populated towards the NWDAF. The pre collection phase provides an improvement compared to existing approaches that scatter information among individual network functions, without sharing the information with any central node for more informed and correlated decision. This section describes examples of information available at different network nodes like the AF, the base station system (BSS), etc. and proposes collating the same at the NWDAF. The NWDAF node is an analytics node introduced in 5G which will support Automation and Analytics needed for the 5G architecture to be agile and dynamic in terms of scale out/scale in based on dynamic network conditions. The present disclosure proposes sharing one or more of the following with the NWDAF:
a) Application Functions (AF) Status sharing (in terms of the current load/Service Quality)
b) BSS system sharing the User specific revenue information
c) OSS sharing the performance information to NWDAF
d) LADN NWDAF sharing the information to Central NWDAF.

Application Function Status Sharing

In certain embodiments, selection of an Application Server or Application Function (“AS/AF”) (whether trusted or untrusted) may be based on whether or not the AS/AF is overloaded. As an example, suppose that it is better not to connect new users located in the service area of a LADN if the AS/AF associated with the LADN is 90% overloaded, for example, because adding new users can further increase the load and lead to detrimental experience for existing customer. In this scenario, it may be preferred to connect new users to a centralized application server (or to an AS/AF associated with another LADN if such AS/AF is not overloaded and if the users are located in the service area of the other LADN and have subscriptions that permit access to the other LADN).

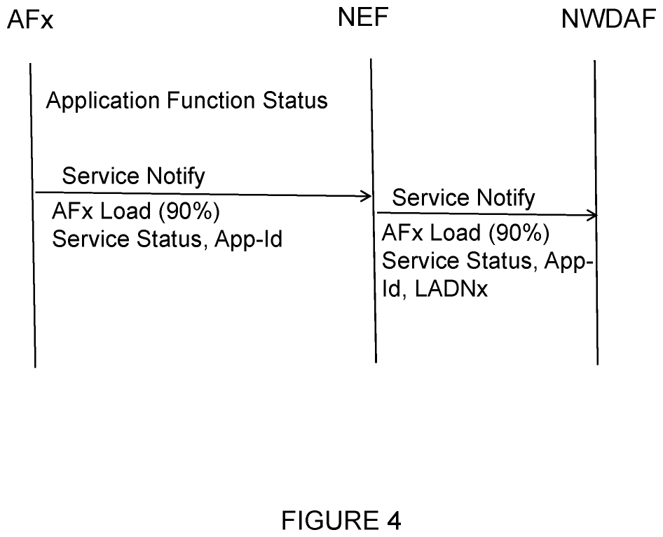

As shown in FIG. 4, when the AS/AF is overloaded (there can be multiple reason that the AS/AF is overloaded), it may report this status in real-time to an NWDAF via a NEF. The NEF reports the status to the NWDAF, and the NWDAF stores the status in a repository to be used in future transactions. For example, overload status of an Application Server (in LADN) with, e.g., 90% CPU load is stored. The status report may be a collated in a load profile of several properties (CPU, Memory, Network), collected over time reaching a threshold value that triggers the report, etc. Please note that NEF is an optional node in case the AFx is a trusted node in the operators environment. As per European Telecommunications Standards Institute Mobile Edge Computing (ETSI MEC) standards, an Application Server for a third party can be co-hosted by an operator on the operators environment, or the Application server can be hosted in the 3rd party data center.

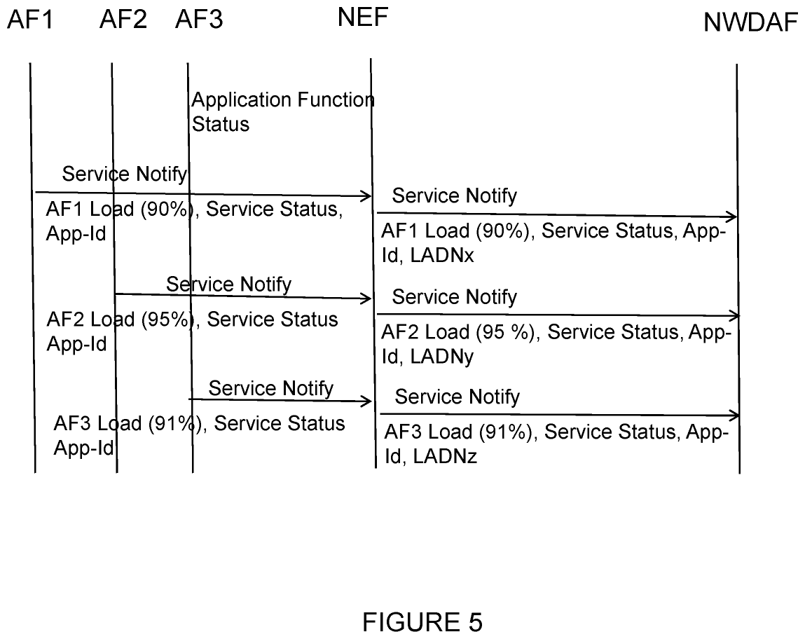

FIG. 5 illustrates an example in which multiple AS/AFs report their status to an NWDAF (e.g., via a NEF). For example, AF1 reports a status indicating a 90% load, AF2 reports a status indicating a 95% load, and AF3 reports a status indicating a 91& load. This data is saved in NWDAF as historical data set. NWDAF then uses these details for providing the response to AMF queries regarding LADN. This data is also used for predicting overload situation in the future by analyzing the past trends. Table 1 illustrates an example of data that may be saved by the NWDAF based on receiving the status messages from AF1, AF2, and AF3.

TABLE 1
Server Load and Service Status Data

| Application | | | Service | |
|---|---|---|---|---|
| Function | Time | Load | Deterioration | LADN |
| AF Server 1 | 2018-10-13: 05:15:00 | 90% | No | LADN-X |
| AF Server 2 | 2018-10-13: 05:15:00 | 95% | Yes | LADN-Y |
| AF Server 3 | 2018-10-13: 05:15:00 | 91% | No | LADN-Z |

Two different solutions are proposed as to how NWDAF knows which AF is part of which LADN:

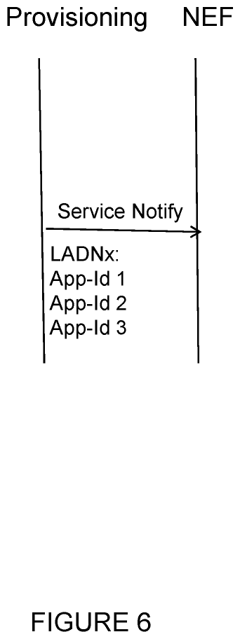

1 The AF may identify itself with an Application ID, which may be indicated to the NEF. This Application ID uniquely identifies the AF. The NEF thus needs to be provisioned with a mapping between different Application IDs and LADN Services. The NEF then provides this Information to the NWDAF. FIG. 6 illustrates an example of provisioning a NEF with particular Application IDs (App-Id 1, App-Id 2, and App-Id 3) associated with a particular LADN (LADNx).

2 The NWDAF predicts a virtual topology of best fit of AF location to LADN.

As a precondition for the second solution, certain embodiments may require the same types of AF to be supported in all LADNs in the region. The NWDAF may receive input parameters, such as UE location, the location of all LADN's, LADN (UPF) IP address ranges, LADN load information, AF id, AF IP address, average experienced AF latency, average AF traffic throughput, use of overlapping AF ID, and use of overlapping IP addresses for the AF's. Based on the input parameter(s) the NWDAF may perform optimization and learning in which the NWDAF tries out and learns (e.g., re-enforcement learning) the best latency and traffic throughput for an AF in a LADN for a various locations of the UE. Note that for overlapping ID and IP addresses, this information has low value and the NWDAF could weight or discard that information, based on the setting of input parameters.

By this method, the NWDAF learns and optimizes a network topology based on the best AF status (latency and throughput) for a given location of the UE. Certain embodiments include a training phase that will give a non-optimal selection of the LADN selection in the beginning during the training session, but over time the selection becomes better and better. Note that the NWDAF may use insights gained from the latency, in relation to AF id, LADN load and AF throughput, to determine the relative importance of AF throughput during the training phase.

By setting input parameter to no overlapping AF ID, solution #2 will be similar to solution #1, with the difference that NWDAF will automatically learn the AF mapping to LADN, and it is done much faster compared to if overlapping AF IDs is used. Overlapping AF IDs or AF IP addresses refers to the use of the same ID and/or IP address for the same type of AF instance in different LADNs. The NWDAF stores this information along with Application Function load and service status information. It uses this information to inform the AMF about the status of the AF when the AMF queries the NWDAF about the LADN information.

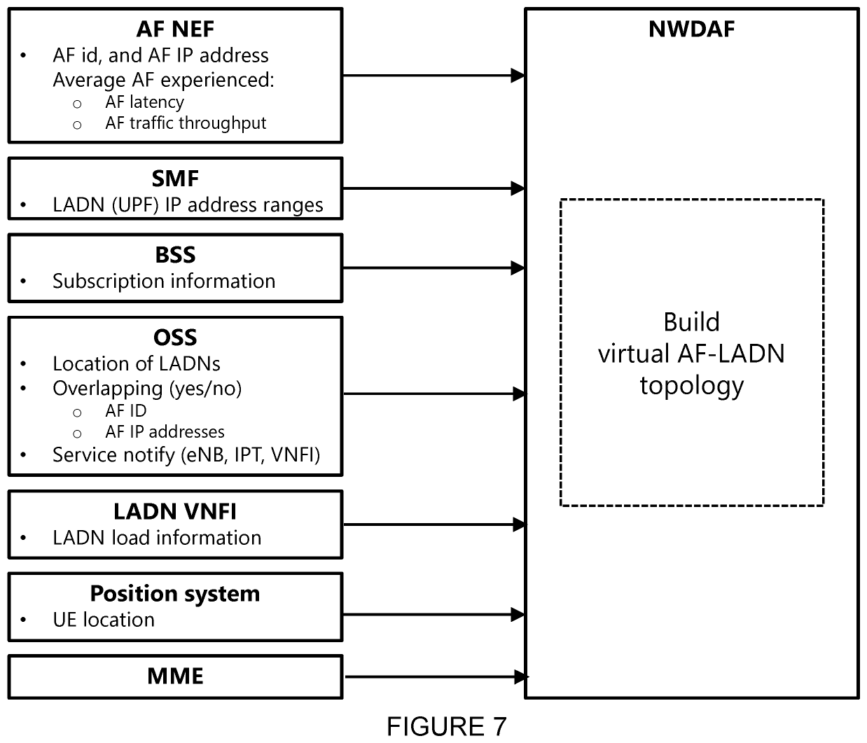

FIG. 7 illustrates an example of the input used for training the NWDAF algorithm as to how the AF-LADN topology looks. In certain embodiments, during initial training, the MME always selects the LADN regardless of load and other information, based on static configured selection of LADN (as defined in 3GPP specifications on 5G LADN use). The generated data shown in the FIG. 7 is fed into the NWDAF to learn the AF topology. The NWDAF filters out anomalies in the reported data, such as large latency response times and traffic delay variations due to traffic overloads, errors, or misbehaving devices and AF.

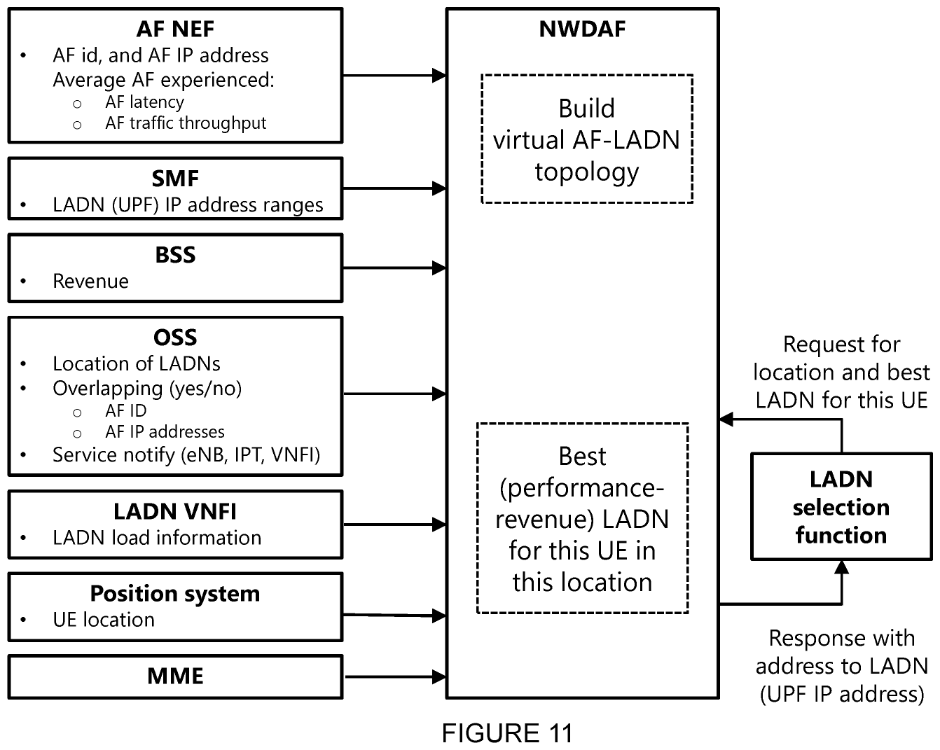

The models are trained to be as close as possible to give a real static topology graph for best selection of the AF with lowest latency and acceptable throughput. In the “post collection phase,” described below (e.g., beginning with the description of FIG. 11), the MME will start using the NWDAF recommendations.

BSS System Sharing the User Specific Revenue Information

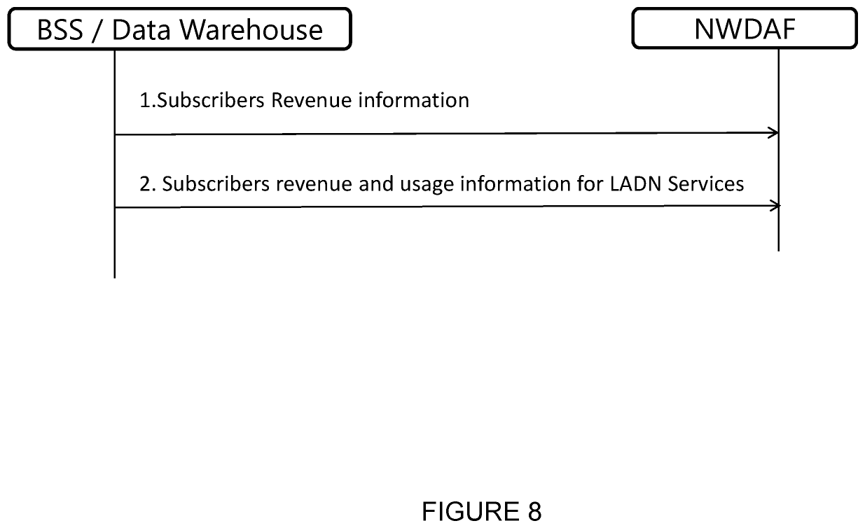

All the services provided by the communication service provider (CSP) need to be monetized. The BSS systems manage monetization. Additionally, the CSP should consider prioritizing among the customers/end users based on the revenue and not on the specific static configuration. Therefore, whenever the CSP is expecting or reaches the overloaded situation, which is very practical situation, the revenue specific information can also be used for decision making. This information will also be stored by the NWDAF node so that the Application function-specific information discussed above (e.g., the AF-specific status discussed with respect to FIGS. 4-5) and the BSS information can be correlated at one network function (NWDAF) to have end-to-end view needed for prioritization decision. FIG. 8 illustrates an example of a BSS or data warehouse providing subscriber revenue information to the NWDAF. The subscriber revenue data includes:

1. Subscriber Revenue information, e.g., Monthly usage & recharge information

2. Subscribers revenue & usage data specific to the LADN Services

TABLE 2
Different Ways to Prioritize Subscribers

| Parameters | Subscriber 1 | Subscriber 2 |
|---|---|---|
| Profile | Gold | Silver |
| ARPU Monthly | 55 USD | 35 USD |
| ARPU LADN Services | 6 USD | 9 USD |

OSS System Sharing the Network Congestion Information

As described above, the Application Function can provide the NEF with Service Quality Status, such as the average latency or average traffic throughput experienced by the AF. Service quality degradation may happen due to many reasons, such as congestion in transport network, congestion in physical or virtual switches, radio conditions, etc. The NWDAF can consider these factors with appropriate information from the OSS. Different elements of the network viz transport and RAN provide the key performance indicator (KPI) information to a centralized OSS that can relay the information to the NWDAF for analysis & decision making.

Whenever the CSP predicts/expects or reaches the overloaded situation, revenue-specific information can also be used for decision making. This information will also be stored by the NWDAF node so that Application function-specific information described above (see e.g., description of FIGS. 4-7) and BSS information can be correlated at one network function (NWDAF) to have an end-to-end view that facilitates the prioritization decision.

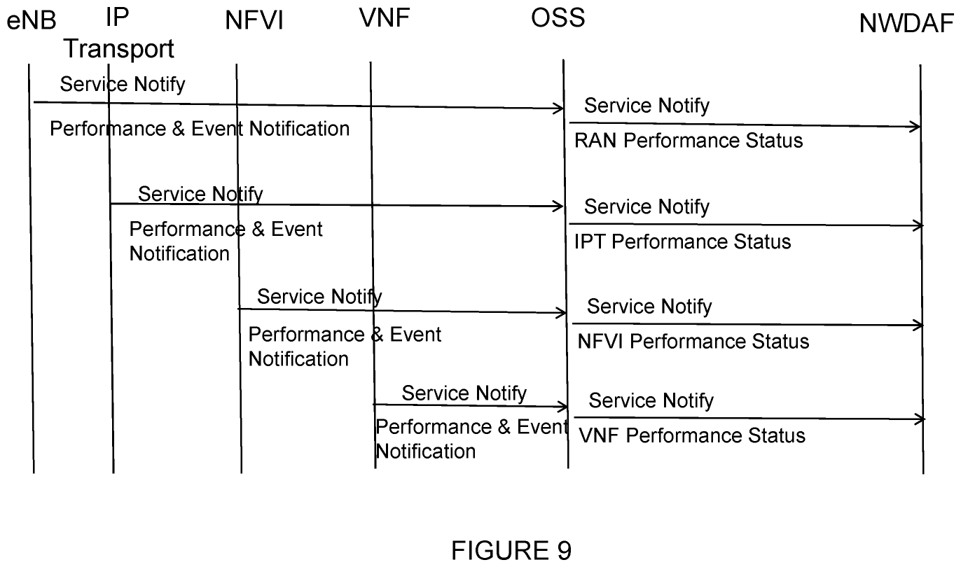

FIG. 9 illustrates a call flow in which different network elements (e.g., eNB, IP Transport, Network Function Virtualization Infrastructure (NFVI), Virtual Network Function (VNF)) provide performance related data to the OSS. The OSS updates the NWDAF with relevant performance information so that the NWDAF can decide which network elements may be contributing to the congestion.

NWDAF Federated Learning in Case of LADN Specific NWDAF

As discussed above, FIGS. 1 and 2 illustrate different deployment options. With respect to the option illustrated in FIG. 2, a separate NEF and NWDAF are deployed for the LADN service. So, updates related to AF Status & Service Quality are made to the LADN NWDAF. This Information is shared by the LADN NWDAF to the central NWDAF so that the central NWDAF can make better decisions at network level.

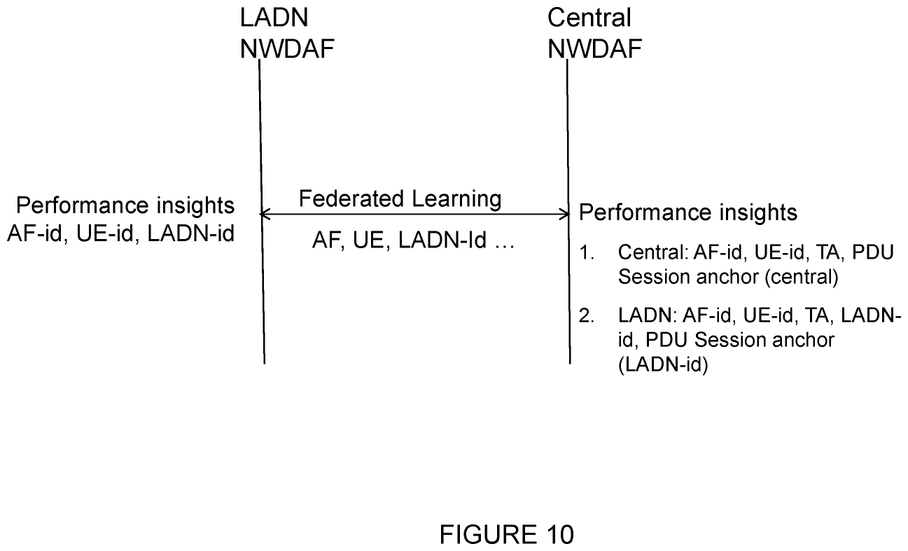

FIG. 10 illustrates a call flow in which information related to the LADN (AF, LADN-ID, Performance Insights etc.) is shared between the LADN NWDAF and the central NWDAF. The central NWDAF may use information obtained from the LADN NWDAF to build a super set of information for all of the NWDAFs deployed in LADNs across sites but in same PLMN.

### Post Collection Phase:

Once sufficient information has been collected at the NWDAF (which may be referred to as a “post collection phase”), the NWDAF can be used for providing recommendations to the “LADN selection function” in the AMF. As discussed above, examples of information collected at the NWDAF may include, but is not limited to, Application Function load status, user-specific revenue information, etc. When applying a policy related to selecting a LADN (e.g., UPF+AF) based in part on the location of the wireless device, the AMF may connect with the NWDAF for further input/feedback to enable optimized decision making to select the preferred LADN for the wireless device in a given area for a given time. In certain embodiments, the preferred LADN may be based on the LADN that generates the most revenue, the LADN that provides the best performance (e.g., best service quality), or the LADN that provides the best balance between revenue and performance. As an example, suppose that LADNs A, B, and C are available for selection, and that LADN A provides the most revenue, LADN B provides the second most revenue, and LADN C provides the third most revenue of the set. Further suppose that LADN C provides the best service quality, LADN B provides the second best service quality, and LADN A provides the third best service quality of the set. Certain embodiments may select LADN A (to obtain the most revenue), other embodiments may select LADN C (to obtain the best performance), and other embodiments may select LADN B (to obtain a balance between revenue and performance).

FIG. 11 illustrates an example in which a request for the best LADN may be sent to the NWDAF, and the NWDAF may make a recommendation based on reinforced learning. As can be seen in FIG. 11, the NWDAF may continue collecting additional information and refining its recommendations during the post collection phase. For example, the NWDAF may update its recommendations based on the current loading conditions (e.g., latency, traffic throughput) of the various AFs.

In this phase “post collection phase” the MME will start using the NWDAF recommendations, starting with the initial trained models above, and based on the recommendation that the NWDAF gives, the NWDAF learns the impacts on changes done in the policy to select the best LADN for an AF. In this phase NWDAF will try to select a better alternative LADN for an AF instance to learn the impact of previous recommendations, and by this tune the model for more optimal selection next time. In certain embodiments, input data to the NWDAF has a time stamp so that the NWDAF learns the performance of the AF, LADN, and UE locations over time to create a daily performance profile to consider as an integral part of the NWDAF data that is processed.

There may be several use-cases where the NWDAF node will be contacted before making any decision by control plane to attach/change respective LADN setup, including the following use cases:
a) Handling the AF overloaded and Service Quality deterioration (including new sessions and ongoing sessions) e.g. Overloaded situation already reached.
b) Proactively prioritize new session based on AF load condition (based on historical data): AMF Connecting with NWDAF to proactively figure out the overload situation and prioritizing the users based on static network configuration.
c) Proactively prioritize on revenue generation by Customer: AMF Connecting with NWDAF to proactively figure out the overload situation and prioritizing the users based on respective revenue generations

Use Case A: Handling the AF Overload and Service Quality Deterioration

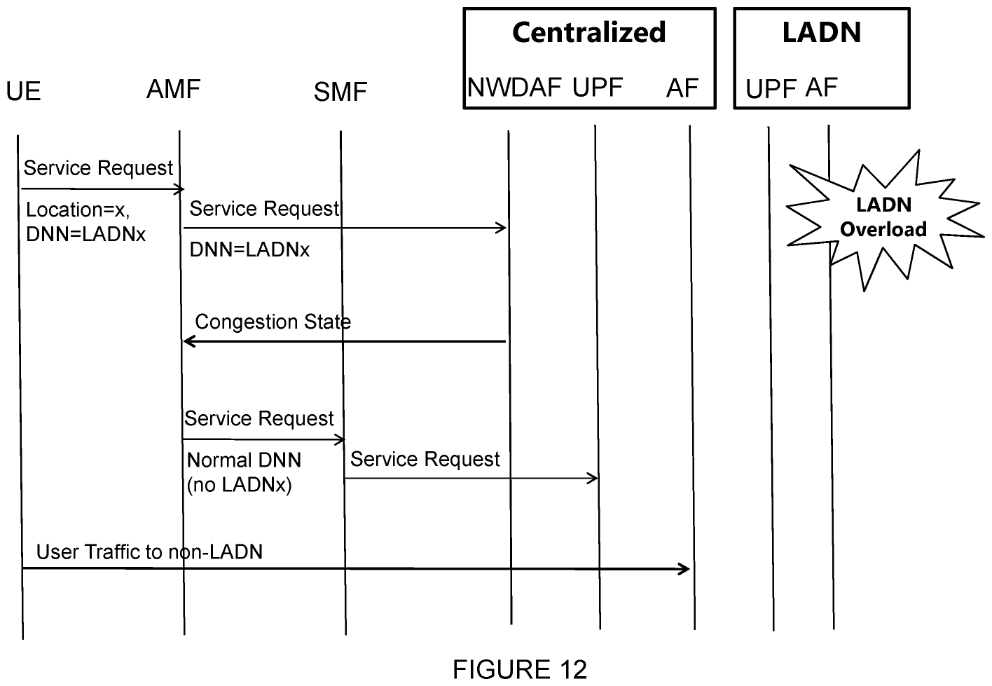

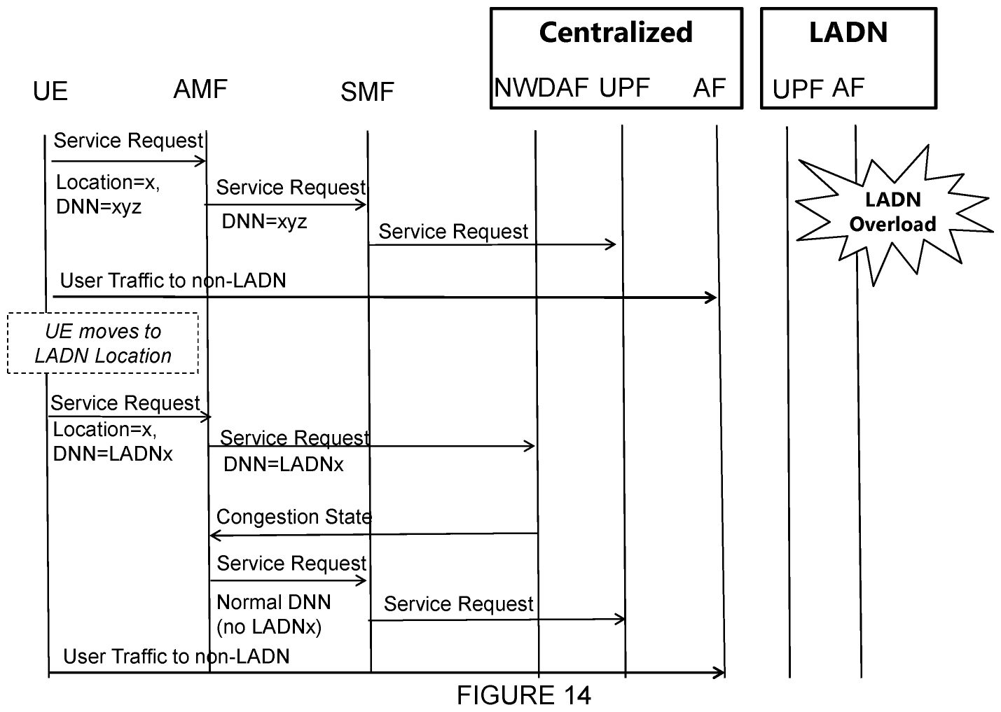

The following description of use case A includes two different call flows. The first call flow (FIG. 12) relates to the scenario when subscriber is already in the LADN area and is trying to connect to the LADN services. This scenario can be considered as a new session for LADN. So, the network needs to decide if this user is to be connected to LADN network or not. The second call flow is for the subscriber that moves to the LADN area (FIG. 14). The subscriber is already using some services through the centralized application server, but the LADN is also capable of providing these services. So, when the subscriber moves to the LADN area, the network needs to decide whether to keep the session with the existing AF or to move the session to the LADN AF. Because the subscriber in this case is already using services and has already established that these services are available from centralized services.

As discussed above, FIG. 3 illustrates an example of an existing call flow for connecting a new session. When the UE initiates a service Request for a content which is in LADN, such as Netflix, the AMF selects the corresponding LADN based on the UE subscription and location. In the existing call flow, the AMF does not consider the overload situation, so all requests are sent to the LADN. In FIG. 3, when the UE performs a successful (Re)registration procedure, the AMF may provide a Registration Accept message to the UE. The Registration Accept message includes information indicating the list of LADNs available to the UE in that Registration Area. The information may be based on local configuration (e.g., via OAM) about LADN, UE location, and UE subscription information received from the UDM about subscribed DNN(s).

1. When the UE is in a LADN service area, the UE:
may request a PDU Session Establishment/Modification for this LADN DNN;
may request to activate UP connection of the existing PDU Session for this LADN DNN.

2. UE sends PDU Session Establishment with LADN DNN or Service Request with the established PDU Session corresponding to LADN.

3. The AMF determines UE presence in LADN service area and forwards it to the SMF if the requested DNN is configured at the AMF as a LADN DNN.

4. The SMF supporting a DNN is configured with information about whether this DNN is a LADN DNN or not. When receiving SM request corresponding an LADN from the AMF, the SMF determines whether the UE is inside LADN service area based on the indication (i.e. UE Presence in LADN service area) received from the AMF. If the SMF does not receives the indication, the SMF considers that the UE is outside of the LADN service area (in which case the SMF rejects the request because the UE is outside of the LADN service area). The SMF subscribes to “UE mobility event notification” for reporting UE presence in Area of Interest by providing LADN DNN to the AMF.

5. When SMF is informed that the UE presence with respect to a LADN service area is “IN,” the SMF ensures that Downlink Data Notification is enabled. The network triggers a Service Request procedure for a LADN PDU Session to activate the UP connection when the SMF receives downlink data or Data Notification from UPF.

6. UE is then able to create data connection with AF which is part of LADN. It leads to network failure as LADN AF is already overloaded.

FIG. 12 illustrates an enhanced call flow for a new session, in accordance with certain embodiments of the present disclosure. As shown in FIG. 12, when the AMF considers the load situation of the Application Function, it can choose not to select the LADN. In FIG. 12, the AMF queries the NWDAF with LADN DNN information. NWDAF checks from the repository any information related to AFs related to that LADN. Mapping of LADN to AFs is configured in NWDAF as part of initial provisioning which is not part of the described call flow.

1. When the UE is in a LADN service area, the UE:
may request a PDU Session Establishment/Modification for this LADN DNN;
may request to activate UP connection of the existing PDU Session for this LADN DNN.

2. UE sends PDU Session Establishment with LADN DNN or Service Request with the established PDU Session corresponding to LADN.

3. The AMF determines UE presence in LADN service area and requests the status of the LADN from the NWDAF. The NWDAF provides the decision for LADN selection based on the AF load, service quality, and network congestion. Note in the example of FIG. 12, the AMF requests the status from a central NWDAF (such as shown in FIG. 1). In other embodiments, the AMF may request the status from a LADN-specific NWDAF (such as shown in FIG. 2).

4. AMF decides that the subscriber should connect to a centralized server, rather than to the LADN, to avoid an overload failure at the AF associated with the LADN.

5. AMF then forwards it to the SMF with non-LADN DNN.

6. The SMF connects to centralized (default) UPF & AF for call processing as per normal procedures.

7. UE is then able to create data connection with AF which is part of centralized (default) network.

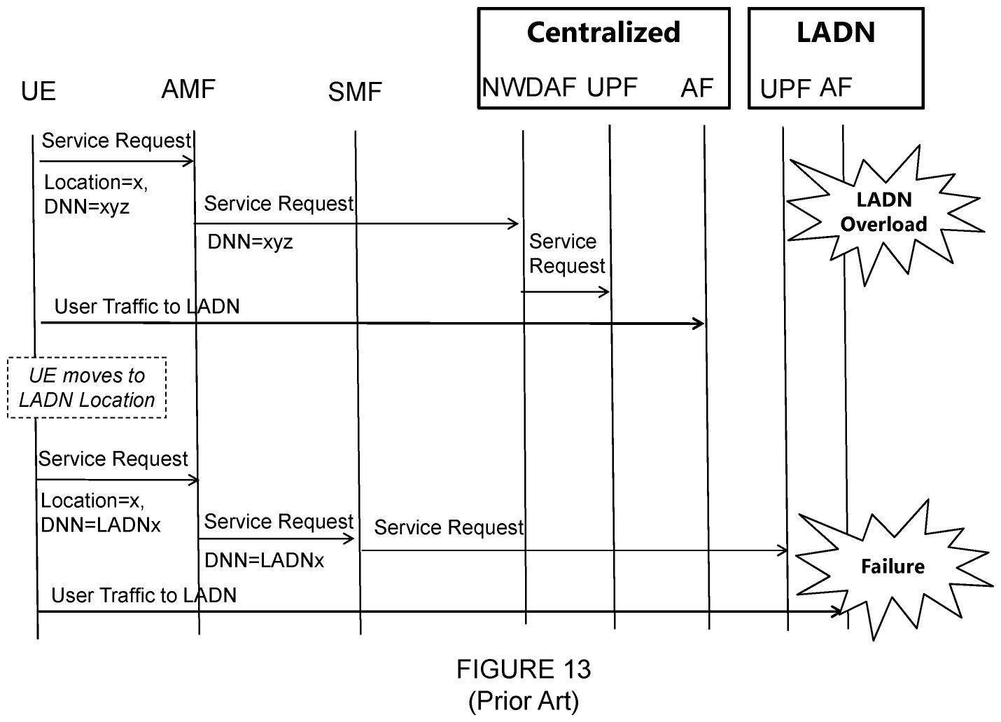

FIGS. 13 and 14 illustrate examples in which a UE with an ongoing session moves into a LADN area. As an example, this may occur when the user is roaming and currently the session is ongoing with a centralized network (e.g., centralized network is providing an application, such as Netflix) and the user is approaching a location where the session needs to be transferred to LADN/UPF/Edge. In particular, FIG. 13 illustrates a call flow for existing solutions wherein the decision whether to connect to the LADN is based on subscriber location and whether the subscriber is subscribed to the LADN. In the existing call flow, the decision whether to connect to the LADN is not based on the loading conditions, service quality, historic data, and subscriber priority (e.g., NWDAF is not part of decision making). FIG. 14 illustrates a call flow with enhancements proposed according to certain embodiments of the present disclosure. In FIG. 14, the decision whether to connect to the LADN is based on the loading conditions, service quality, historic data, and/or subscriber priority (e.g., NWDAF is part of decision making).

With respect to FIG. 13, currently, the AMF does not consider the overload situation so all requests are sent to the LADN according to the following call flow:

1. UE is in non-LADN area and sends a service request to AMF.

2. This request is processed by AMF as standard Service request. AMF Chooses SMF Based on DNN. This can be static or based on DNS (not shown in flow).

3. SMF selects the centralized UPF based on configuration for this session, user is able to connect the centralized AF.

4. When the UE moves to another geographical area which is part of a LADN service area, the UE:
may request a PDU Session Establishment/Modification for this LADN DNN;
may request to activate UP connection of the existing PDU Session for this LADN DNN.

5. UE sends PDU Session Establishment with LADN DNN or Service Request with the established PDU Session corresponding to LADN.

6. The AMF determines UE presence in LADN service area and forwards it to the SMF if the requested DNN is configured at the AMF as a LADN DNN.

7. The SMF supporting a DNN is configured with information about whether this DNN is a LADN DNN or not. When receiving SM request corresponding an LADN from the AMF, the SMF determines whether the UE is inside LADN service area based on the indication (i.e. UE Presence in LADN service area) received from the AMF. If the SMF does not receives the indication, the SMF considers that the UE is outside of the LADN service area. (The SMF then reject the request if the UE is outside of the LADN service area.) The SMF subscribes to “UE mobility event notification” for reporting UE presence in Area of Interest by providing LADN DNN to the AMF.

8. When SMF is informed that the UE presence a LADN service area is IN, the SMF ensures that Downlink Data Notification is enabled. Triggers the Network triggered Service Request procedure for a LADN PDU Session to active the UP connection when the SMF receives downlink data or Data Notification from UPF.

9. UE is then able to create data connection with AF which is part of LADN. It leads to network failure as LADN AF is already overloaded.

FIG. 14 illustrates an embodiment proposed in the present disclosure. In the embodiment, the AMF considers the Load situation of the Application Function and can choose not to select the LADN if the LADN is overloaded or at risk of becoming overloaded. The call flow of FIG. 14 includes the following steps:

1. UE is in non-LADN area and sends a service request to AMF.

2. This request is processed by AMF as standard Service request. AMF Chooses SMF Based on DNN. This can be static or based on DNS (not shown in flow).

3. SMF selects the centralized UPF based on configuration for this session, user is bale to connect the centralized AF.

4. When the UE moves to another geographical area which is part of a LADN service area, the UE:
may request a PDU Session Establishment/Modification for this LADN DNN;
may request to activate UP connection of the existing PDU Session for this LADN DNN.

5. UE sends PDU Session Establishment with LADN DNN or Service Request with the established PDU Session corresponding to LADN.

6. The AMF determines UE presence in LADN service area and requests NWDAF (Central NWDAF in case of Alternative 1) about the status of LADN. NWDAF provides the decision for LADN selection based on the AF load, service quality & network congestion.

7. AMF decides that subscriber should not connect to LADN NW but to a centralized server to avoid the overload failure at AF.

8. AMF then forwards it to the SMF with non-LADN DNN.

9. The SMF connects to centralized (default) UPF & AF for call processing as per normal procedures.

10. UE is then able to create data connection with AF which is part of centralized (default) network.

Use Case B: Proactively Prioritize New Session Based on AF Load Condition (Based on Historical Data)

If, the above overload situation is taking place regularly, a historical data repository can be used to predict such situation. This means that the NWDAF will have a historical information on when the AS/AF typically have been overloaded, in terms of time of day, day of week, day of the year, or other times of overload, such as when new contents are released (new television series), promotional offers by AF/AS (Netflix). In that case, the NWDAF can perform the predictive analysis even before the congestion happened so that low priority customers are not tagged to the LADN network even when the network is not congested (but probable to have congestion in future).

As discussed above, FIG. 3 illustrates a call flow for existing solutions wherein the decision whether to connect to the LADN is based on subscriber location and whether the subscriber is subscribed to the LADN. In the existing call flow, the decision whether to connect to the LADN is not based on the loading conditions, service quality, historic data, and subscriber priority (e.g., NWDAF is not part of decision making). When the UE performs a successful (Re)registration procedure, the AMF may provide to the UE, based on local configuration (e.g. via OAM) about LADN, on UE location, and on UE subscription information received from the UDM about subscribed DNN(s), the LADN Information for the list of LADN available to the UE in that Registration Area in the Registration Accept message. The call flow of FIG. 3 includes the following steps:

1. When the UE is in a LADN service area, the UE:
may request a PDU Session Establishment/Modification for this LADN DNN;
may request to activate UP connection of the existing PDU Session for this LADN DNN.

2. UE sends PDU Session Establishment with LADN DNN or Service Request with the established PDU Session corresponding to LADN.

3. The AMF determines UE presence in LADN service area and forwards it to the SMF if the requested DNN is configured at the AMF as a LADN DNN.

4. The SMF supporting a DNN is configured with information about whether this DNN is a LADN DNN or not. When receiving SM request corresponding an LADN from the AMF, the SMF determines whether the UE is inside LADN service area based on the indication (i.e. UE Presence in LADN service area) received from the AMF. If the SMF does not receives the indication, the SMF considers that the UE is outside of the LADN service area. (The SMF then reject the request if the UE is outside of the LADN service area.) The SMF subscribes to “UE mobility event notification” for reporting UE presence in Area of Interest by providing LADN DNN to the AMF.

5. When SMF is informed that the UE presence a LADN service area is IN, the SMF ensures that Downlink Data Notification is enabled. Triggers the Network triggered Service Request procedure for a LADN PDU Session to active the UP connection when the SMF receives downlink data or Data Notification from UPF.

6. UE is then able to create data connection with AF which is part of LADN. It leads to network failure as LADN AF is already overloaded.

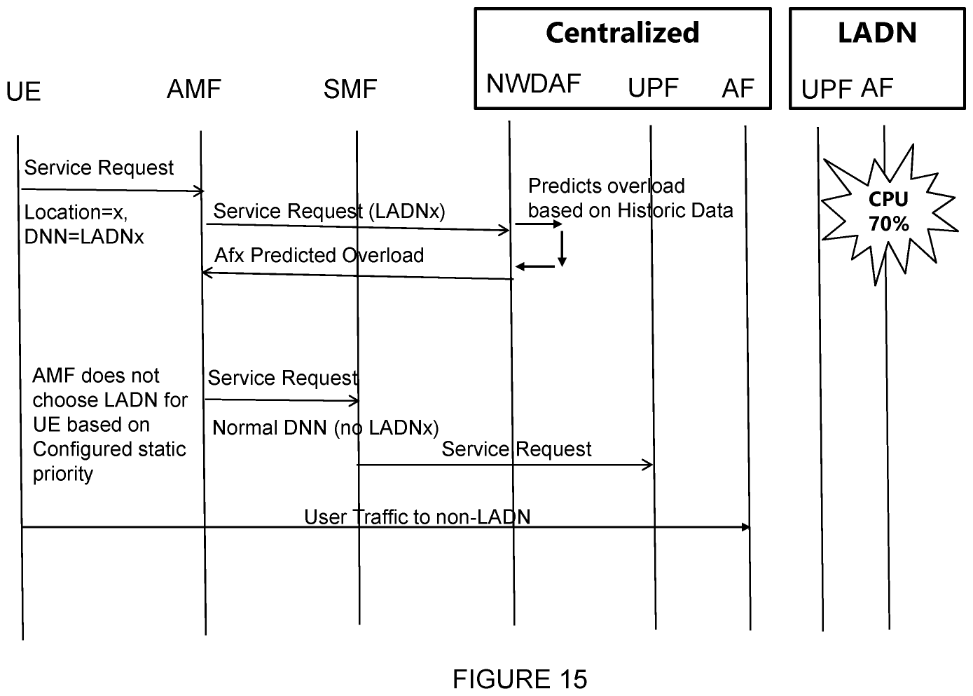

FIG. 15 provides an example of a call flow in which predictions are considered in determining whether to connect the wireless device to the LADN, in accordance with certain embodiments of the present disclosure. FIG. 15 illustrates the following steps:

1. When the UE is in a LADN service area, the UE:
may request a PDU Session Establishment/Modification for this LADN DNN;
may request to activate UP connection of the existing PDU Session for this LADN DNN.

2. UE sends PDU Session Establishment with LADN DNN or Service Request with the established PDU Session corresponding to LADN.

3. The AMF determines UE presence in LADN service area and requests NWDAF (Central NWDAF in case of Alternative 1) about the status of LADN.

4. NWDAF predicts the overload\congestion situation. NWDAF analyzes the historical data, time, date and number of subscribers etc. Based on these parameters, NWDAF calculates that AF in the LADN network is nearing the situation where service quality will deteriorate. (In case of Alternative 2, this prediction may be made by LADN NWDAF and shared with central NWDAF). So, it notifies the AMF so that it does not choose this AF for further subscriber session requests.

5. AMF decides that subscriber should not connect to LADN network. Instead, that subscriber should connect to a centralized server to avoid the overload failure at AF.

6. AMF then forwards it to the SMF with non-LADN DNN.

7. The SMF connects to centralized (default) UPF & AF for call processing as per normal procedures.

8. UE is then able to create data connection with AF which is part of centralized (default) network.

Use Case C: Prioritized Based on Customer Priority

Once the congestion happens or is predicted to happen, the operator can choose various parameters that the NWDAF may consider when providing recommendations. In certain embodiments, the BSS System will populate the data in NWDAF regarding UE average monthly revenue, revenue per AP, revenue profile, however in case prioritization is needed among similar profile subscribers (prioritize on user with higher revenue). The OSS system will populate the data of network and RAN congestion situation. So, the NWDAF can decide if choosing the LADN will improve the Service Quality or not.

In some cases, it may be better to prioritize a user with lower Monthly Plan but higher spending (with top-ups/LADN-specific revenue, etc.) than a user with higher monthly plan but lower spending (e.g., a subscriber that generates less LADN-specific revenue). Alternatively, it may be better to prioritize a user with higher overall spending.

TABLE 3
Different Ways to Prioritize Subscribers

| Parameters | Subscriber 1 | Subscriber 2 |
|---|---|---|
| Profile | Gold | Silver |
| ARPU Monthly | 55 USD | 35 USD |
| ARPU LADN Services | 6 USD | 9 USD |
| RAN Condition | Poor | Good |

In addition, or in the alternative, other factors may be considered when prioritizing subscribers. For example, a user with poor radio conditions may not be able to utilize the benefit of LADN services as the bottleneck is on the RAN part of the network. So, prioritizing that subscriber will not improve service quality for that user but may limit the other users (due to limited resources) from enjoying better service quality with LADN. A congestion in IP transport or NFVI layer can have similar effect which makes service improvement by LADN negligible. As an example, if a user is closer to the cell border, then more of the radio resources must be consumed in communication with that user, compared to a user close to the antenna site. With a proportional fair radio scheduler that schedules the use of radio resources in a fair way between users, the user on the cell edge may get worse performance. To mitigate this one alternative is to let the user on the cell edge use QoS with a dedicated bearer allocating more radio resources, and then let other users suffer from worse performance (in case the radio system is close to saturated). For example, maybe 2 users (or more users) will experience bad performance instead of the user on the cell edge that then gets the better performance.

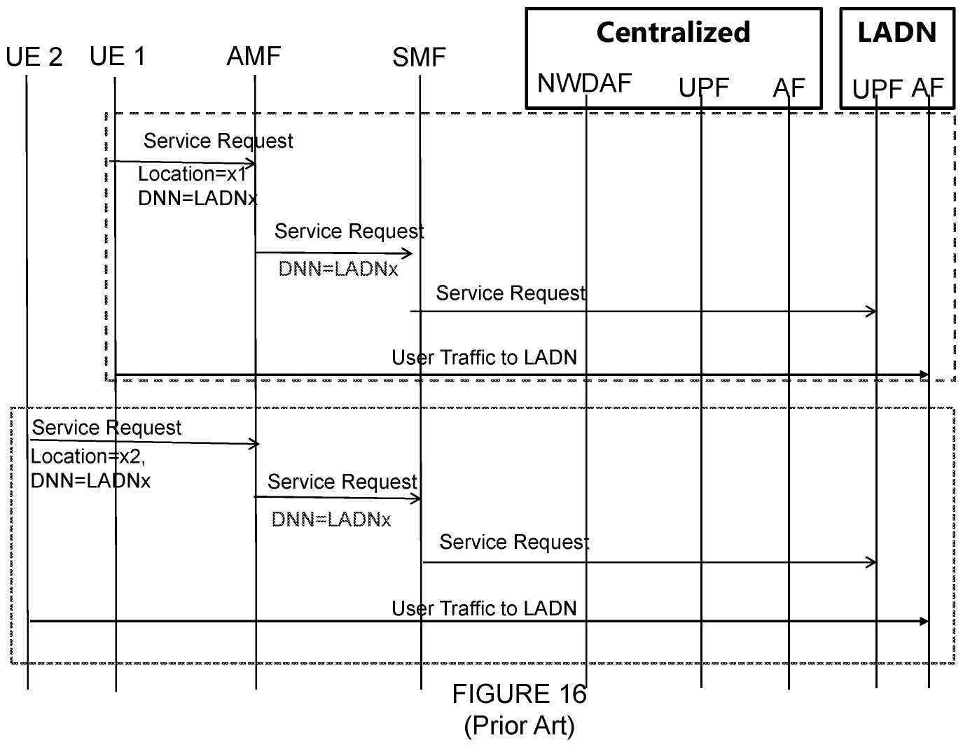

FIG. 16 illustrates an existing solution in which subscriber priority can be defined in static way based on the IMSI or DNN details in the UDF & AMF. These subscribers are treated the same way in case of LADN selection by AMF. FIG. 16 illustrates the following steps:

1. Subscribers with different Priority UE1—Gold Customer and UE2—Silver customer connect to LADN NW.

2. When the UE 1 is in a LADN service area, the UE:
may request a PDU Session Establishment/Modification for this LADN DNN;
may request to activate UP connection of the existing PDU Session for this LADN DNN.

3. UE1 sends PDU Session Establishment with LADN DNN or Service Request with the established PDU Session corresponding to LADN.

4. The AMF determines UE1 presence in LADN service area and forwards it to the SMF if the requested DNN is configured at the AMF as a LADN DNN.

5. For UE1, AMF follows the normal procedure irrespective of the subscriber priority and revenue status.

6. The SMF supporting a DNN is configured with information about whether this DNN is a LADN DNN or not. When receiving SM request corresponding an LADN from the AMF, the SMF determines whether the UE is inside LADN service area based on the indication (i.e. UE Presence in LADN service area) received from the AMF. If the SMF does not receives the indication, the SMF considers that the UE is outside of the LADN service area. (The SMF then reject the request if the UE is outside of the LADN service area.) The SMF subscribes to “UE mobility event notification” for reporting UE presence in Area of Interest by providing LADN DNN to the AMF.

7. When SMF is informed that the UE1 presence a LADN service area is IN, the SMF ensures that Downlink Data Notification is enabled. Triggers the Network triggered Service Request procedure for a LADN PDU Session to active the UP connection when the SMF receives downlink data or Data Notification from UPF.

8. UE1 is then able to create data connection with AF which is part of LADN. It may lead to network failure as LADN AF is already overloaded.

9. For UE2, AMF follows the same procedure irrespective of the subscriber priority and revenue status.

10. UE2 is also connected to LADN network.

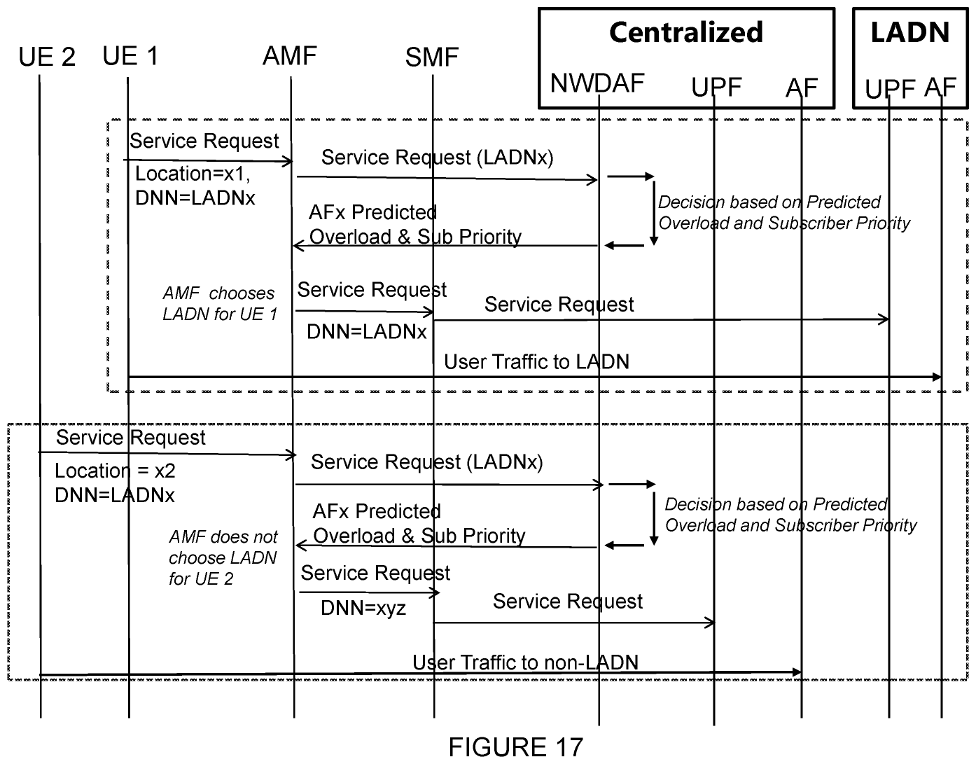

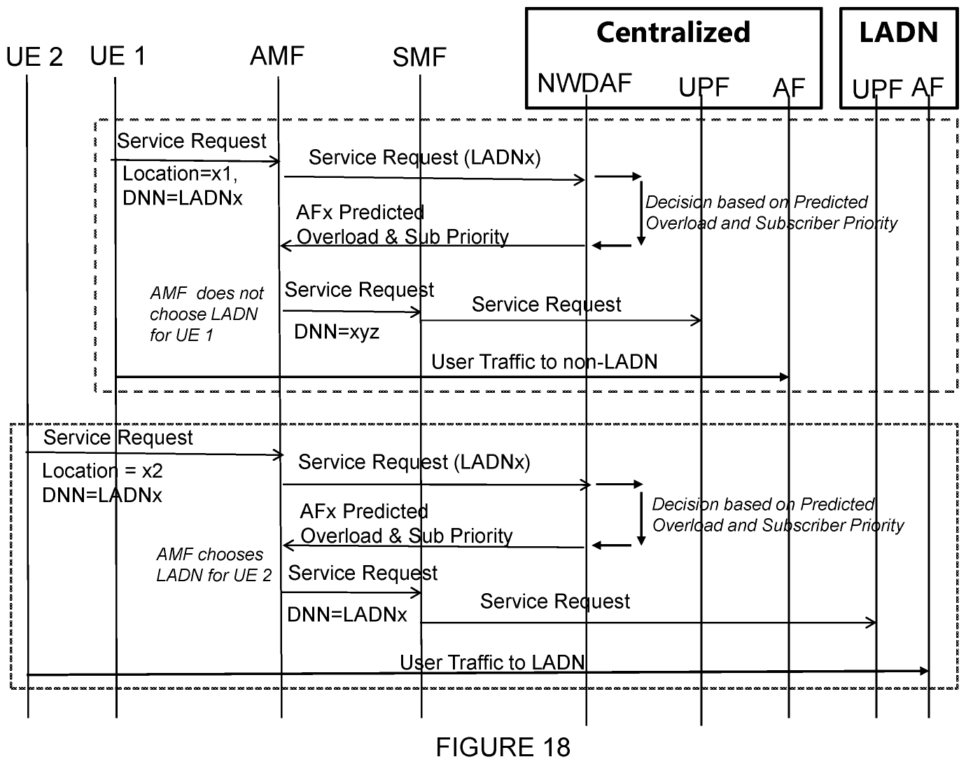

FIGS. 17 and 18 illustrate embodiments of the present disclosure in which priority can be used for LADN selection by AMF. In particular, FIG. 17 illustrates an example in which subscriber priority can be defined in static way based on the IMSI or DNN details in the UDF & AMF. FIG. 18 illustrates an example in which subscriber priority can be defined dynamically.

The call flow for FIG. 17 (static subscriber priority) includes the following steps:

1. Subscribers with different Priority UE1—Gold Customer and UE2—Silver customer connect to LADN NW.

2. When the UE 1 is in a LADN service area, the UE:
may request a PDU Session Establishment/Modification for this LADN DNN;
may request to activate UP connection of the existing PDU Session for this LADN DNN.

3. UE1 sends PDU Session Establishment with LADN DNN or Service Request with the established PDU Session corresponding to LADN.

4. The AMF determines UE1 presence in LADN service area and forwards it to the SMF if the requested DNN is configured at the AMF as a LADN DNN.

5. NWDAF predicts the overload\congestion situation. NWDAF analyzes the historical data, time, date and number of subscribers etc. (In case of Alternative 2, this prediction may be made by LADN NWDAF and shared with central NWDAF).

6. Based on these parameters, NWDAF calculates that AF in the LADN network is nearing the overload situation.

7. AMF uses the static Priority configured based on IMSI or DNN etc. to select the high priority for UE1 as it is Gold Customer. It does not chose the LADN & selects centralized server for UE2 as it is lower priority Silver Customer.

8. AMF decides that UE2 should not connect to LADN NW but to a centralized server to avoid the overload failure at AF.

9. AMF then forwards it to the SMF with non LADN DNN.

10. The SMF connects to centralized (default) UPF & AF for call processing as per normal procedures.

11. UE2 is then able to create data connection with AF which is part of centralized (default) network.

12. For UE1, AMF selects LADN and UE1 able to create data connection with AF which is part of LADN.

The call flow for FIG. 18 (dynamic subscriber priority) includes the following steps:

1. Subscribers with different Priority UE1—Silver Customer and UE2—Gold customer connect to LADN NW.

2. When the UE is in a LADN service area, the UE:
may request a PDU Session Establishment/Modification for this LADN DNN;
may request to activate UP connection of the existing PDU Session for this LADN DNN.

3. UE sends PDU Session Establishment with LADN DNN or Service Request with the established PDU Session corresponding to LADN.

4. The AMF determines UE presence in LADN service area and requests NWDAF (Central NWDAF in case of Alternative 1) about the status of LADN.

5. NWDAF predicts the overload\congestion situation. NWDAF analyzes the historical data, time, date and number of subscribers etc. (In case of Alternative 2, this prediction may be made by LADN NWDAF and shared with central NWDAF). NWDAF also uses revenue information from BSS system (see e.g., FIG. 11 and the discussion of Table 3). This information includes overall subscriber monthly uses, revenue, latest recharge and LADN services specific revenue & usage information. NWDAF also uses NW performance information from OSS (as discussed above). This information includes network condition, for example, congestion level of different functions.

6. Based on these parameters, NWDAF calculates that AF in the LADN network is nearing the overload situation. And, decides on the Priority for the Subscriber.

7. So, it notifies AMF to not to choose LADN for UE1 session as LADN AF is nearing overload as per the historical data and UE1 is low priority (dynamic) subscriber. This lower priority is calculated based on revenue as well as radio conditions. For example, if UE has poor radio coverage or it is at cell edge where service quality cannot be improved by selecting LADN.

8. It notifies the AMF to choose LADN for UE2 as it is higher priority (dynamic) subscriber. This higher priority is calculated based on revenue as well as radio conditions. For example, if UE has better radio coverage or it is near the antenna, where service quality can be improved by selecting LADN.

9. AMF decides that UE1 should not connect to LADN NW but to a centralized server to avoid the overload failure at AF.

10. AMF then forwards it to the SMF with non LADN DNN.

11. The SMF connects to centralized (default) UPF & AF for call processing as per normal procedures.

12. UE1 is then able to create data connection with AF which is part of centralized (default) network.

13. For UE2, AMF selects LADN and UE2 able to create data connection with AF which is part of LADN.

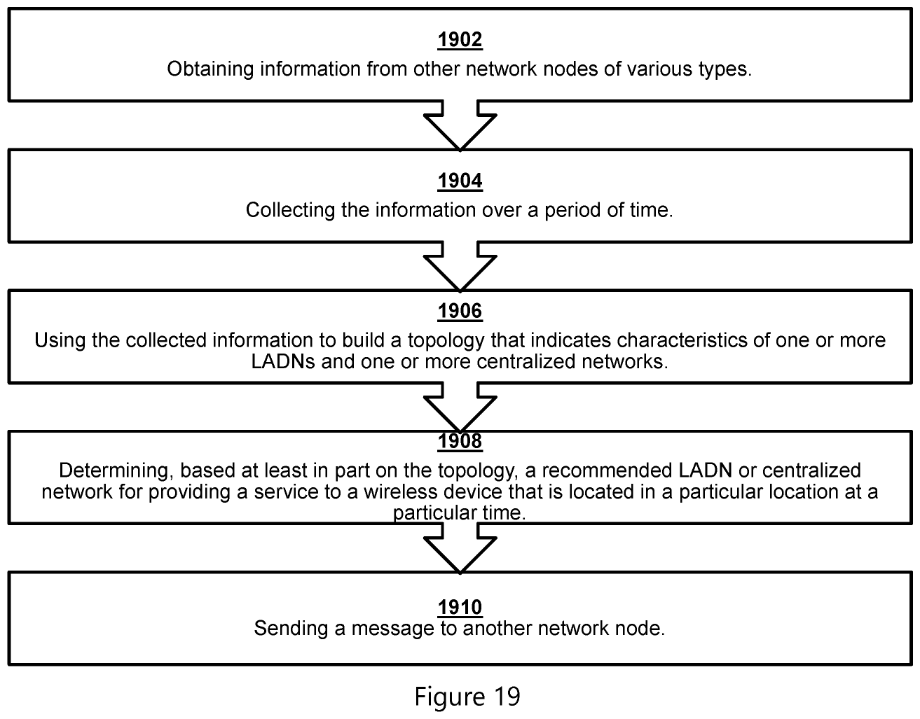

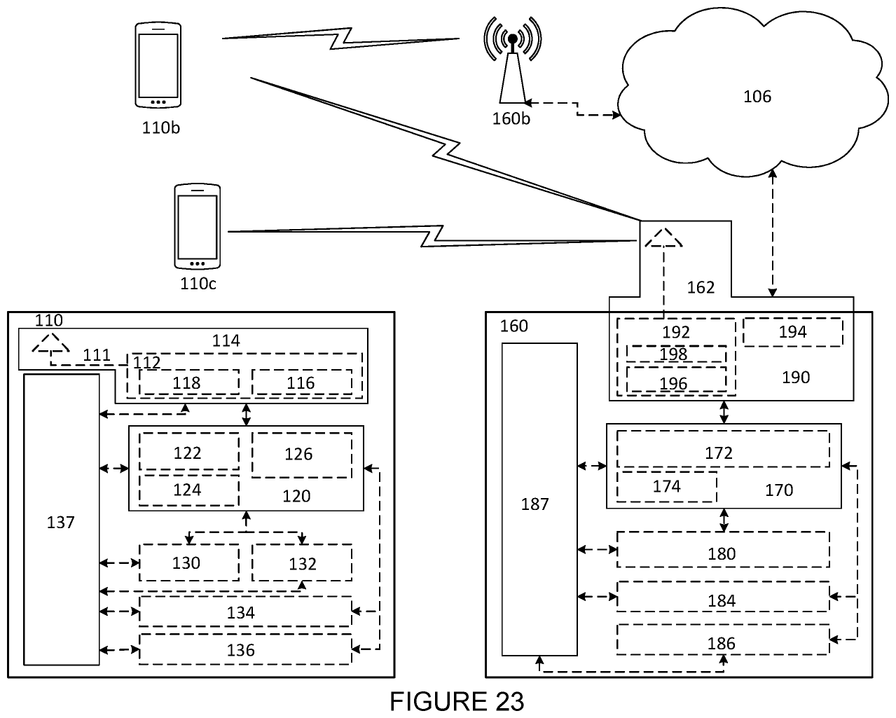

FIG. 19 depicts a method in accordance with particular embodiments. In some embodiments, the method may be performed by a network node 160 (which, as discussed below with respect to FIG. 23, may be a core network node). In some embodiments, the method may be implemented in a node that provides features related to analytics, such as a node comprising an NWDAF. The node may be located in an edge data center or a central data center, for example, as described with respect to the NWDAF in FIGS. 1-2. In general, the method of FIG. 19 may be used to perform all or a portion of the “Pre Collection Phase” discussed above.

The method begins at step 1902 with obtaining information from other network nodes of various types. Examples of the other network nodes from which the information may be obtained include one or more of: AF(s), AS(s), SMF(s), BSS(s), OSS(s), VNFI(s), position system(s), and/or MME(s). The information may be obtained directly from these nodes, or indirectly via intermediate nodes. Examples of information that may be obtained from the other network nodes include one or more of the following: information indicating latency of one or more application functions in the network, information indicating traffic throughput of one or more application functions in the network, information indicating IP address ranges associated with the LADN, information indicating revenue associated with one or more subscribers, information indicating a location of the LADN (location could mean geographic location (e.g., longitude, latitude) or logical location, for example, based on connections and delay characteristics between nodes of the network (which may change dynamically based on network conditions, such as load)), information indicating whether a service area of the LADN overlaps the service area of another LADN, information indicating a load of the LADN (which may include information indicating the load of a component of the LADN, such as an AS or AF within the LADN), information indicating a load of network segments that application traffic is carried over (such as information that is received from OSS and which may indicate a load of network segments within the LADN, outside of the LADN (e.g., network segments in another LADN or in a centralized network), or both), and information indicating a location of a wireless device (e.g., wireless device 110 or UE 200 discussed below). The information may include information collected in real time, covering historical data, and predicated information regarding a future time period. Additional discussion of information that can be obtained and the various network nodes from which such information may be obtained is provided above, for example, with respect to FIG. 7.

The method proceeds to step 1904 with collecting the information over a period of time. As an example, the information may be collected until at least a threshold level of information has been obtained. As another example, the information may be collected for a pre-determined time period, such as a day, a week, a month, or other pre-determined time period. Collecting the information over a period of time may allow the network node to have sufficient information to determine trends, such as peak and/or average traffic throughput or latency in various portions of the network at various times of day, for various days of the week, etc.

At step 1906, the network node uses the collected information to build a topology that indicates characteristics of one or more LADNs and one or more centralized networks. FIGS. 7-11 above discuss examples of building a topology. After building the topology, the method may continue to obtain information from the other network nodes and update the topology based on changing trends within the network and/or current network conditions.

In certain embodiments, the method further comprises using the topology to determine a recommended LADN or centralized network for providing a service to a wireless device that is located in a particular location at a particular time, as shown in step 1908. An example is described above with respect to FIG. 11 (e.g., the network node may receive a request for location and best LADN for a UE, and may respond with a UPF ID address associated with the best LADN). In certain embodiments, the topology is used to predict whether selecting the recommended LADN or centralized network for the wireless device at the particular location would increase revenue. In certain embodiments, the topology is used to predict whether selecting the recommended LADN or centralized network for the wireless device at the particular location would improve service quality. In certain embodiments, both revenue and service quality are considered (e.g., if increasing revenue would degrade service quality, the network node may select a LADN or centralized network that balances trade-offs based on the amount of revenue effected and the degree of impact on service quality).

In certain embodiments, the method further comprises sending a second network node a message at step 1910. The message indicates the recommended LADN or centralized network. The second network node is configured to facilitate connecting the wireless device with the recommended LADN or centralized network. As an example, FIGS. 11, 12, 14, 15, 17, and 18 illustrate examples in which a first network node (such as an NWDAF) sends a message to a second network node (such as an AMF) so that the second network node can facilitate connecting the wireless device with the recommended LADN or centralized network. In certain embodiments, the recommended LADN or centralized network may be indicated explicitly by the first network node. In other embodiments, the recommended LADN or centralized network may indicated implicitly by the first network node. For example, the first network node may indicate that a requested LADN is congested or predicted to become congested, which implicitly indicates that another LADN or centralized network is recommended for providing the service to the wireless device.

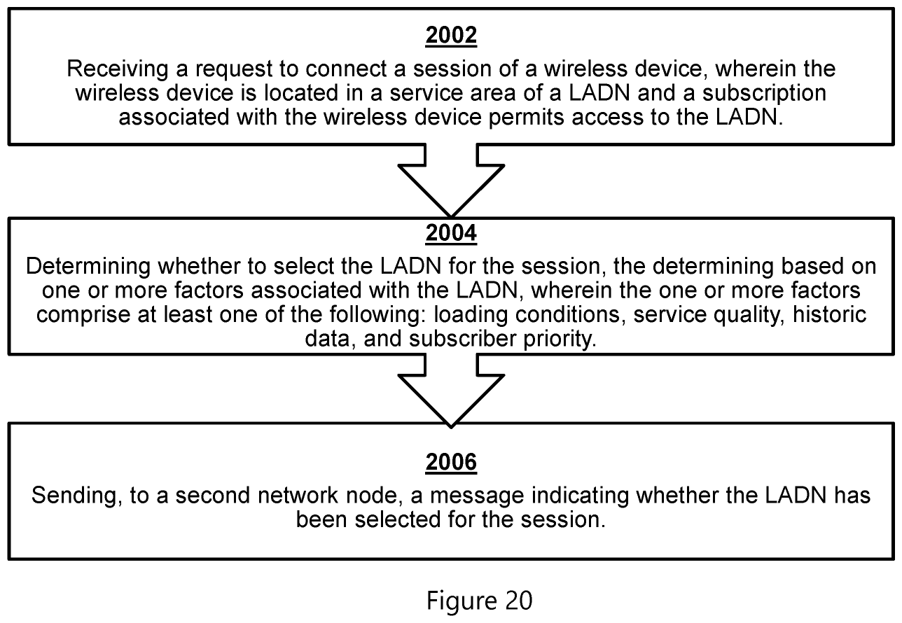

FIG. 20 depicts a method in accordance with particular embodiments. In some embodiments, the method may be performed by a network node 160 (which, as discussed below with respect to FIG. 23, may be a core network node). As an example, in some embodiments, the method may be implemented in a node that facilitates connecting a wireless device to an AF, such as a node comprising an AMF. As another example, in some embodiments, the method may be implemented in a node that provides features related to analytics, such as a node comprising an NWDAF. The node may be located in an edge data center or a central data center, for example, as described with respect to the NWDAF in FIGS. 1-2. In general, the method of FIG. 20 may be used to perform all or a portion of the “Post Collection Phase” discussed above.

The method may begin at step 2002 with receiving a request to connect a session of a wireless device (e.g., wireless device 110 or UE 200 discussed below). The wireless device is located in a service area of a LADN and a subscription associated with the wireless device permits access to the LADN. The method proceeds to step 2004 with determining 2004 whether to select the LADN for the session. The determining is based on one or more following factors associated with the LADN: loading conditions, service quality, historic data, and subscriber priority. Further explanation of these factors is provided above.

As an example, in certain embodiments, the determination in step 2004 is based at least in part on loading conditions and it is determined not to select the LADN when the loading conditions indicate that the LADN is overloaded. The LADN may be considered overloaded when a component thereof, such as an AF, AS, etc., is overloaded. When the loading conditions indicate that the LADN is not overloaded, the determination may either proceed with connecting the wireless device to the requested LADN (if there are not any other factors to be checked) or with checking other factors (if there are other factors to be checked, such as service quality, historic data, and/or subscriber priority).

As another example, in certain embodiments, the determination in step 2004 is based at least in part on service quality and it is determined not to select the LADN when the service quality in the LADN is degraded. Service quality may be obtained in any suitable manner, such as based on comparing LADN performance to per-determined thresholds or other criteria, or based on receiving status information from another node indicating that the service quality is degraded in the LADN. When the service quality in the LADN is acceptable, the determination may either proceed with connecting the wireless device to the requested LADN (if there are not any other factors to be checked) or with checking other factors (if there are other factors to be checked, such as loading conditions, historic data, and/or subscriber priority).

As another example, in certain embodiments, the determination in step 2004 is based at least in part on historic data. A determination not to select the LADN is made when the historic data predicts that the LADN is at risk of becoming overloaded or the service quality in the LADN is at risk of becoming degraded. Examples of collecting data and building a topology that predicts LADN performance are described above with respect to FIGS. 7-11. When the historic data predicts that the LADN is not at risk of becoming overloaded and the service quality in the LADN is not at risk of becoming degraded, the determination may either proceed with connecting the wireless device to the requested LADN (if there are not any other factors to be checked) or with checking other factors (if there are other factors to be checked, such as existing loading conditions, service quality, and/or subscriber priority). In some embodiments, the historic data predicts that the requested LADN is likely to provide the session with better service quality than other networks that are available for selection, in which case a determination is made to select the requested LADN.

In some embodiments, the method uses the loading conditions, the service quality, and/or the historic data to determine whether to use the subscriber priority as one of the factors for determining whether to select the LADN. When the loading conditions, the service quality, and/or the historic data indicate that there is no need to restrict selection of the LADN, the LADN is selected for the session regardless of the subscriber priority. By contrast, when the loading conditions, the service quality, and/or the historic data indicate a need to restrict selection of the LADN, the method determines to use subscriber priority as one of the factors. Accordingly, the requested LADN is selected for a higher priority subscriber and is not selected for a lower priority subscriber. Subscriber priority may be determined in any suitable manner. In some embodiments, the subscriber priority may be a static configured parameter in the subscriber profile (and stored in a database). In other embodiments, the subscriber priority may be a dynamic parameter. For example, the subscriber priority may be a dynamic parameter that gets updated based on the revenue generated by a subscription (which may vary over time), based on the radio conditions currently being experienced by the subscriber, or both. In addition, or in the alternative, other factors may be used to prioritize subscribers. With respect to revenue, subscriber priority may be based on ARPU (e.g., either total revenue or LADN-specific revenue) such that a higher ARPU subscriber may be prioritized over a lower ARPU subscriber. With respect to radio conditions, a subscriber in good radio conditions may be prioritized over a subscriber in poor radio conditions. Further examples and explanation of prioritizing subscribers are further described above with respect to FIGS. 17-18.

At step 2006, the method sends a message to a second network node. The second network node is configured to facilitate connecting the wireless device with the recommended LADN or centralized network. The message indicates whether the LADN requested in step 2002 has been selected for the session. When the LADN has not been selected for the session, the message sent to the second network node may indicate another node that has been selected for the session (such as a centralized network or a different LADN).

As discussed above, in some embodiments, the method of FIG. 20 may be performed by an AMF. For example, at step 2002, the AMF may receive a service request from the wireless device that is located in the service area of the LADN and subscribed to the LADN. At step 2004, the AMF may determine whether to select the LADN. In some embodiments, the AMF may make the determination based on information obtained from another node (such as an NWDAF) that collects data and provides data analytics for the network. The information may include loading conditions, service quality, historic data, and/or subscriber priority. At step 2006, the AMF sends a message to a second network node (e.g., SMF) indicating whether the LADN has been selected. For example, the AMF may send an SMF a service request that identifies the LADN (thereby indicating that the LADN was selected) or identifies a centralized network or a different LADN (thereby indicating that the requested LADN was not selected).

As discussed above, in some embodiments, the method of FIG. 20 may be performed by an analytics node, such as an NWDAF. For example, at step 2002, the analytics node may receive a service request from the wireless device (e.g., via an AMF). The wireless device is located in the service area of the LADN and subscribed to the LADN. At step 2004, the analytics node determines whether to select the LADN. In some embodiments, the analytics node may make the determination based on information obtained from the pre-collection phase discussed above with respect to FIGS. 7-11 and 19. The information may include loading conditions, service quality, historic data, and/or subscriber priority. At step 2006, the analytics node sends a message to a second network node (e.g., AMF) indicating whether the LADN has been selected. For example, the analytics node may send the AMF a message that identifies the LADN (thereby indicating that the LADN was selected). As described above, the analytics node may identify the LADN by providing an address to the LADN (e.g., UPF IP address). Alternatively, the analytics node may provide a message that identifies a centralized network or a different LADN (thereby indicating that the requested LADN was not selected).

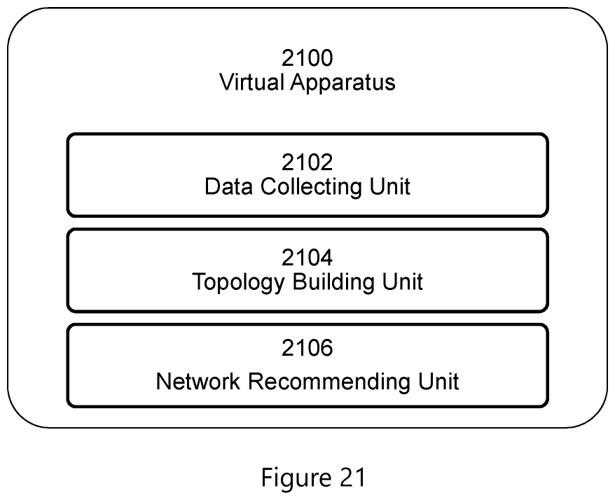

FIG. 21 illustrates a schematic block diagram of an apparatus 2100 that may be implemented in a network node. For example, apparatus 2100 may be implemented in network node 160 (which, as discussed below with respect to FIG. 23, may be a core network node). In some embodiments, apparatus 2100 may be implemented in a node that provides features related to analytics, such as a node comprising an NWDAF. The node may be located in an edge data center or a central data center, for example, as described with respect to the NWDAF in FIGS. 1-2. Apparatus 2100 is operable to carry out the example method described with reference to FIG. 19 and possibly any other processes or methods disclosed herein. It is also to be understood that the method of FIG. 19 is not necessarily carried out solely by apparatus 2100. At least some operations of the method can be performed by one or more other entities.

Virtual Apparatus 2100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Data Collecting Unit 2102, Topology Building Unit 2104, Network Recommending Unit 2106, and any other suitable units of apparatus 2100 to perform corresponding functions according one or more embodiments of the present disclosure.

As illustrated in FIG. 21, apparatus 2100 includes Data Collecting Unit 2102, Topology Building Unit 2104, and Network Recommending Unit 2106. Data Collecting Unit 2102 is configured to information from other network nodes of various types and collect the information over a period of time, for example, as described with respect to steps 1902 and 1904 of FIG. 19. Topology Building Unit 2104 use the information collected by Data Collecting Unit 2102 to build a topology that indicates characteristics of one or more LADNs and one or more centralized networks, for example, as described with respect to step 1906 of FIG. 19. Network Recommending Unit 2106 receives requests to recommend a network and determines, based at least in part on the topology generated by Topology Building Unit 2104, a recommended LADN or centralized network for providing a service to a wireless device that is located in a particular location ata particular time. Network Recommending Unit 2106 sends a message to another network node indicating which network has been recommended. For example, in some embodiments, Network Recommending Unit 2106 performs steps 1908 and 1910 of FIG. 19.

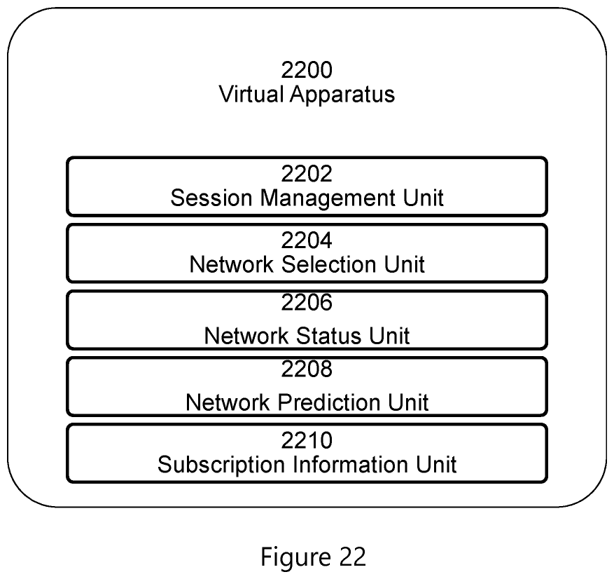

FIG. 22 illustrates a schematic block diagram of an apparatus 2200 that may be implemented in a network node. For example, apparatus 2200 may be implemented in network node 160 (which, as discussed below with respect to FIG. 23, may be a core network node). In some embodiments, apparatus 2200 may be implemented in a node that facilitates connecting a wireless device to an AF, such as a node comprising an AMF. As another example, in some embodiments, apparatus 2200 may be implemented in a node that provides features related to analytics, such as a node comprising an NWDAF. The node may be located in an edge data center or a central data center, for example, as described with respect to the NWDAF in FIGS. 1-2. Apparatus 2200 is operable to carry out the example method described with reference to FIG. 20 and possibly any other processes or methods disclosed herein. It is also to be understood that the method of FIG. 20 is not necessarily carried out solely by apparatus 2200. At least some operations of the method can be performed by one or more other entities.

Virtual Apparatus 2200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Session Management Unit 2202, Network Selection Unit 2204, Network Status Unit 2206, Network Prediction Unit 2208, Subscription Information Unit 2210 and any other suitable units of apparatus 2200 to perform corresponding functions according one or more embodiments of the present disclosure.

As illustrated in FIG. 22, apparatus 2200 includes Session Management Unit 2202, Network Selection Unit 2204, Network Status Unit 2206, Network Prediction Unit 2208, Subscription Information Unit 2210. In general Session Management Unit 2202 receives requests to connect a session of a wireless device (see e.g., step 2002 of FIG. 2) and facilitates connecting the session. The wireless device may be located in the service area of a LADN and may be subscribed to the LADN. Session Management Unit 2202 facilitates connecting the session to the requested LADN or to another network (e.g., centralized network or different LADN) based on information received from Network Selection Unit 2204. Session Management Unit 2202 may then send another network node a message indicating which network was selected in order to proceed with connecting the session, for example, as described with respect to step 2006 of FIG. 20.

Network Selection Unit 2204 determines whether to select the requested LADN for the session, for example, as described with respect to step 2004 of FIG. 20. The determination is based on one or more factors associated with the LADN. The one or more factors comprise at least one of the following: loading conditions, service quality, historic data, and subscriber priority. In some embodiments, Network Selection Unit 2204 obtains the existing loading conditions and/or existing service quality via Network Status Unit 2206, obtains information based on historic data from the Network Prediction Unit 2208 (which may predict whether the requested LADN is at risk of becoming overloaded or having service quality degraded), and obtains subscriber information (such as ARPU-related information or other information for prioritizing subscribers) from Subscription Information Unit 2210. In certain embodiments, Network Status Unit 2206, Network Prediction Unit 2208, and Subscription Information Unit 2210 may obtain their respective information from one or more other nodes in the network.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

Although the subject matter described herein may be implemented in any appropriate type of system using any suitable components, the embodiments disclosed herein are described in relation to a wireless network, such as the example wireless network illustrated in FIG. 23. For simplicity, the wireless network of FIG. 23 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 23, network node 160 includes processing circuitry 170, device readable medium 180, interface 190, auxiliary equipment 184, power source 186, power circuitry 187, and antenna 162. Although network node 160 illustrated in the example wireless network of FIG. 23 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 23 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

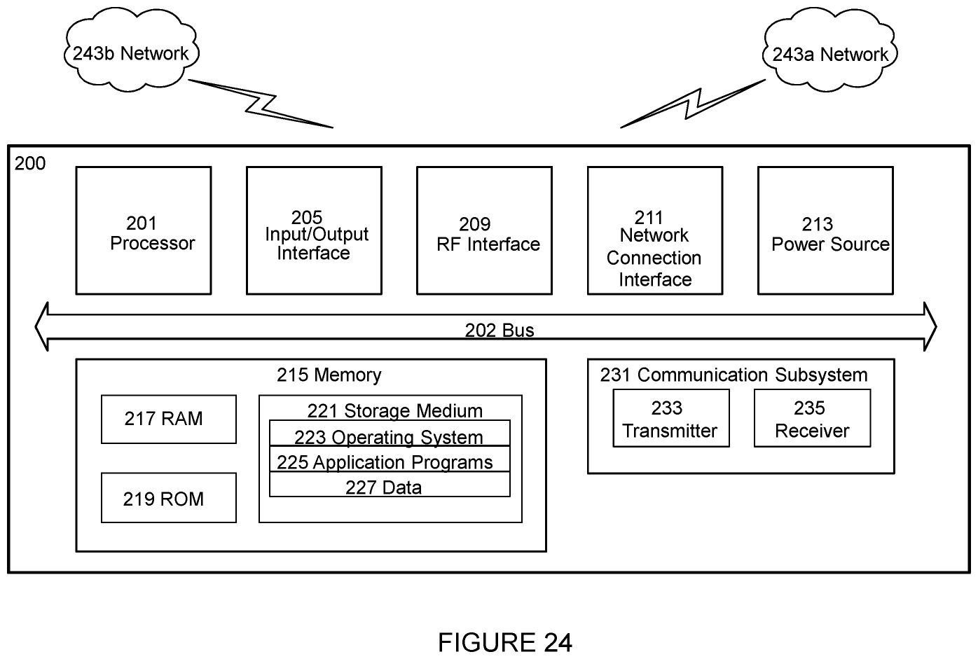

FIG. 24 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 24, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 24 is a UE, the components discussed herein are equally applicable to a WD, and vice-versa.

In FIG. 24, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 24, or only a subset of the components. The level of integration between the components may vary from one UE to another UE. Further, certain UEs may contain multiple instances of a component, such as multiple processors, memories, transceivers, transmitters, receivers, etc.

In FIG. 24, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 24, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 24, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

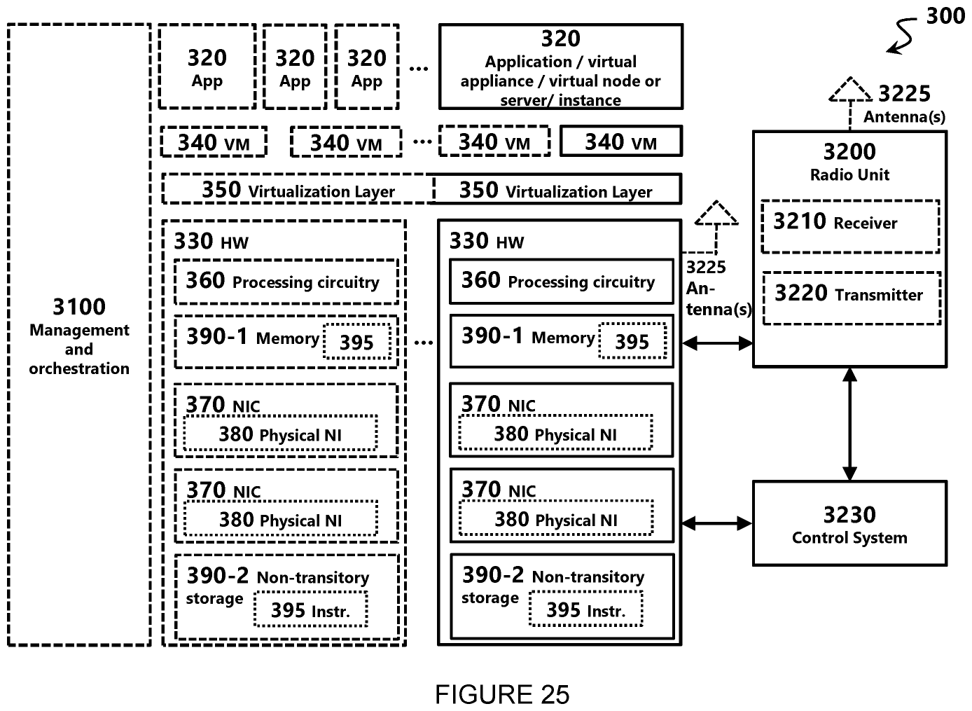

FIG. 25 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 25, hardware 330 may be a standalone network node with generic or specific components. Hardware 330 may comprise antenna 3225 and may implement some functions via virtualization. Alternatively, hardware 330 may be part of a larger cluster of hardware (e.g., such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 25.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

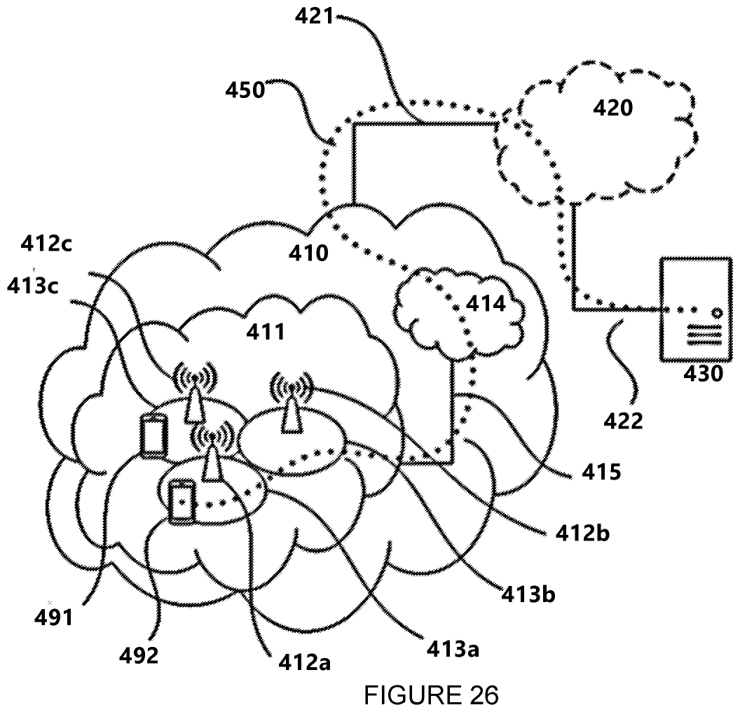

With reference to FIG. 26, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 26 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

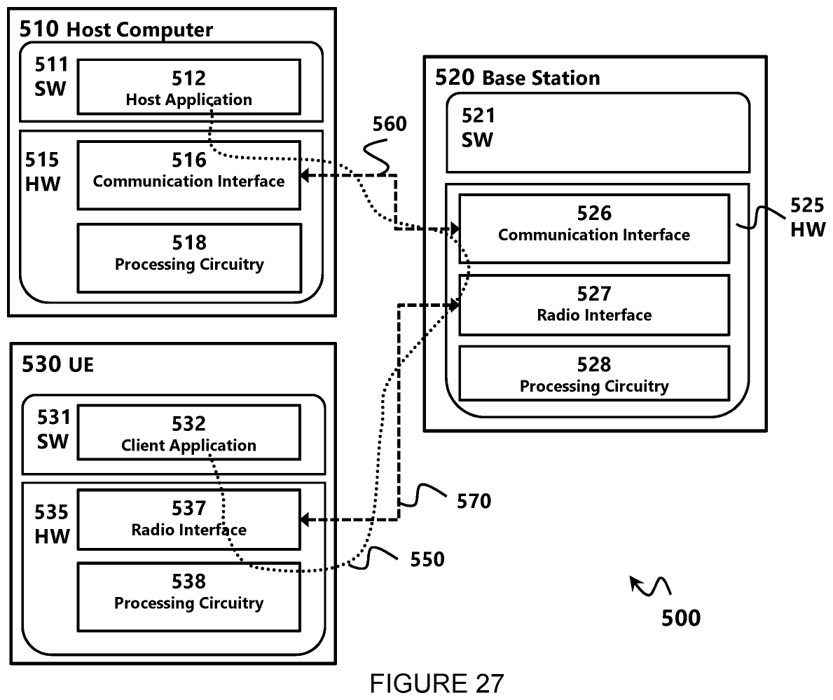

Example implementations, in accordance with an embodiment, of the UE, base station and host computer discussed in the preceding paragraphs will now be described with reference to FIG. 27. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 27) served by base station 520. Communication interface 526 may be configured to facilitate connection 560 to host computer 510. Connection 560 may be direct or it may pass through a core network (not shown in FIG. 27) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 27 may be similar or identical to host computer 430, one of base stations 412a, 412b, 412c and one of UEs 491, 492 of FIG. 26, respectively. This is to say, the inner workings of these entities may be as shown in FIG. 27 and independently, the surrounding network topology may be that of FIG. 26.

In FIG. 27, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate and reduce latency, and thereby provide benefits such as reduced user waiting time, relaxed restriction on file size, or better responsiveness.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

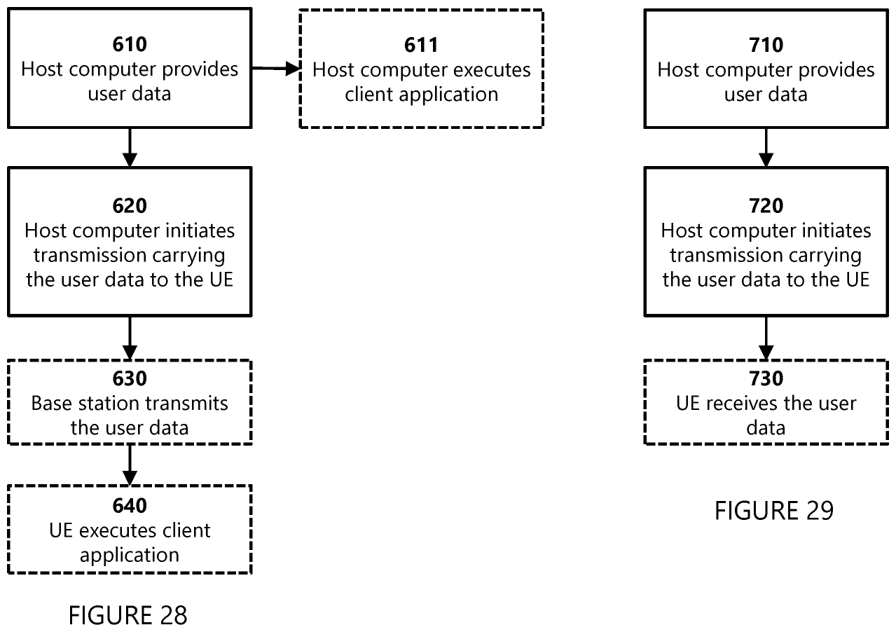

FIG. 28 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 28 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 29 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 29 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

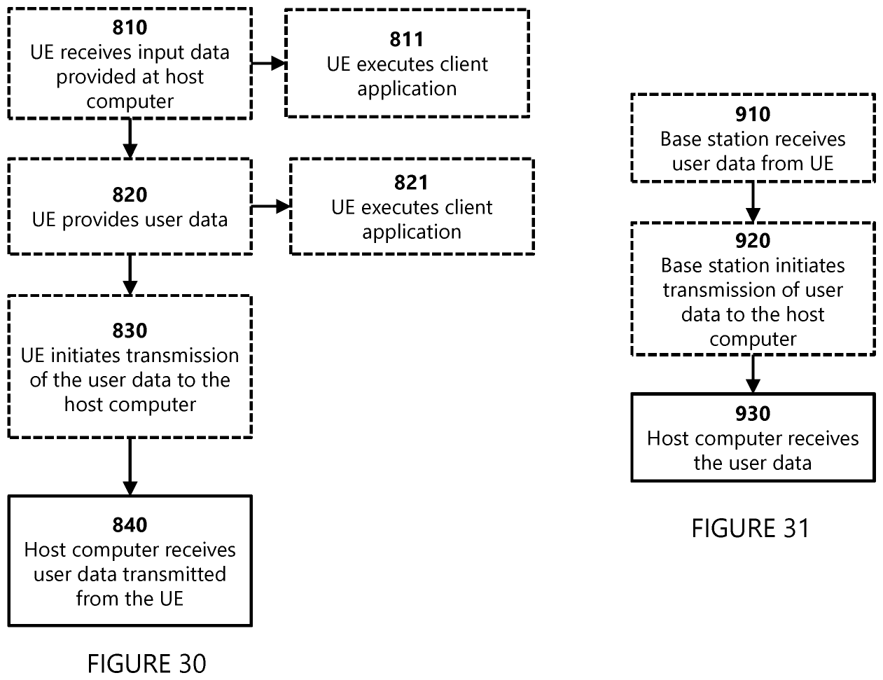

FIG. 30 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 30 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 31 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 31 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

1. A method for use in a first network node, the method comprising:
obtaining information from other network nodes of various types;
collecting the information over a period of time; and
using the collected information to build a topology that indicates characteristics of one or more local area data networks (LADNs) and one or more centralized networks.

2. The method of claim 1, further comprising:
determining a recommended LADN or centralized network for providing a service to a wireless device that is located in a particular location at a particular time, wherein the recommended LADN or centralized network is determined based at least in part on the topology; and
sending a second network node a message indicating the recommended LADN or centralized network, the second network node configured to facilitate connecting the wireless device with the recommended LADN or centralized network.

3. The method of claim 2, wherein determining the recommended LADN or centralized network for providing the service to the wireless device comprises using the topology to predict whether selecting the recommended LADN or centralized network for the wireless device at the particular location would increase revenue or improve service quality.

4. The method of claim 1, wherein the information obtained from the other network nodes comprises one or more of:
information indicating latency of one or more application functions in the network;
information indicating traffic throughput of one or more application functions in the network;
information indicating Internet Protocol (IP) address ranges associated with the LADN;
information indicating revenue associated with a subscriber;
information indicating a location of the LADN;
information indicating whether a service area of the LADN overlaps the service area of another LADN;
information indicating a load of the LADN;
information indicating a load of network segments that application traffic is carried over; and
information indicating a location of a wireless device.

5. The method of claim 1 wherein the other network nodes from which the information is obtained comprise one or more of:
an Application Function (AF);
an Application Server (AS);
a Session Management Function (SMF);
a Base Station System (BSS);
an Operations Support System (OSS);
a LADN Virtual Network Function Instance (VNFI);
a position system; and
a Mobility Management Entity (MME).

6. A first network node comprising processing circuitry, the processing circuitry configured to:
obtain information from other network nodes of various types;
collect the information over a period of time; and
use the collected information to build a topology that indicates characteristics of one or more local area data networks (LADNs) and one or more centralized networks.

7. A method for use in a first network node, the method comprising:
receiving a request to connect a session of a wireless device, wherein the wireless device is located in a service area of a Local Area Data Network (LADN) and a subscription associated with the wireless device permits access to the LADN;
determining whether to select the LADN for the session, the determining based on one or more factors associated with the LADN, wherein the one or more factors comprise at least one of the following: loading conditions, service quality, historic data, and subscriber priority; and
sending a message to a second network node, the message indicating whether the LADN has been selected for the session.

8. The method of claim 7, wherein determining whether to select the LADN comprises determining not to select the LADN when the loading conditions indicate that the LADN is overloaded or that service quality in the LADN is degraded.

9. The method of claim 7, wherein determining whether to select the LADN comprises determining not to select the LADN when the historic data predicts that the LADN is at risk of becoming overloaded or the service quality in the LADN is at risk of becoming degraded.

10. The method of claim 7, wherein determining whether to select the LADN comprises determining to select the LADN when the historic data predicts that the LADN is likely to provide the session with better service quality than other networks that are available for selection.

11. The method of claim 7, further comprising:
determining, based on the loading conditions, the service quality, and/or the historic data, whether to use the subscriber priority as one of the factors for determining whether to select the LADN.

12. The method of claim 11, wherein when the loading conditions, the service quality, and/or the historic data indicate that there is no need to restrict selection of the LADN, the LADN is selected for the session regardless of the subscriber priority.

13. The method of claim 11, wherein when the loading conditions, the service quality, and/or the historic data indicate a need to restrict selection of the LADN, the LADN is selected when the subscription associated with the wireless device corresponds to a higher priority subscriber and the LADN is not selected when the subscription associated with the wireless device corresponds to a lower priority subscriber.

14. The method of claim 13, wherein the subscriber priority is based at least in part on revenue associated with the subscriber.

15. The method of claim 7, wherein, when the LADN has not been selected for the session, the message sent to the second network node indicates a centralized network or a different LADN that has been selected for the session.

16. The method of claim 7, further comprising:
obtaining the one or more factors from a network node that collects data and provides data analytics for the network.

17. A first network node comprising processing circuitry, the processing circuitry configured to:
receive a request to connect a session of a wireless device, wherein the wireless device is located in a service area of a Local Area Data Network (LADN) and a subscription associated with the wireless device permits access to the LADN;
determine whether to select the LADN for the session, the determining based on one or more factors associated with the LADN, wherein the one or more factors comprise at least one of the following: loading conditions, service quality, historic data, and subscriber priority; and
send a message to a second network node, the message indicating whether the LADN has been selected for the session.

18.-21. (canceled)
